(19) United States
(12) Patent Application Publication
(10) Pub. No.: US 2008/0016458 A1
(43) Pub. Date: Jan. 17, 2008

(54) Smart page with prescribed format, layout and function boxes

(76) Inventors: Frederick L. Good, Cambridge, MA (US); Thuy Tu Pham, Norwood, MA (US); Craig A. Stuber, Brentwood, NH (US)

Correspondence Address: KRAMER & AMADO, P.C., 1725 DUKE STREET, SUITE 240, ALEXANDRIA, VA, 22314, US

(21) Appl. No.: 11/819,829

(22) Filed: Jun. 29, 2007

Related U.S. Application Data
(60) Provisional application No. 60/817,359, filed on Jun. 30, 2006.

(51) Int. Cl. G06F 3/048

(52) U.S. Cl. 715/780; 715/764

(57) ABSTRACT

Tools, methods and computer programs for content management, wherein various exemplary embodiments include one or more of the following: an interface for presenting a user with a layout comprising at least one content management module; the at least one content management module enabling a user to provide a desired content within the layout; and the at least one content management module enabling management of the content.

This application claims priority to Provisional Application Ser. No. 60/817,359 filed on Jun. 30, 2006, the contents of which are incorporated herein in their entirety.

### FIELD OF THE INVENTION

The present invention generally relates to content management. The present invention relates to the management of textual, photo and image, web form and e-commerce content.

### BACKGROUND OF THE INVENTION

The Internet today includes millions of web sites hosted on servers around the world. Each website consists of various pages, related or not, that are linked together in various manners to other pages within the same site or to other sites. Websites are created for distributing information, advertising, selling or buying goods and services, and expressing ones' creative nature.

Websites include a variety of pages so as to improve communication with the viewer. Websites commonly include pages containing graphic displays for attracting the viewer's attention, simple text pages for quick and effective communication of information, ecommerce pages for the selling of goods and services, web forms and a variety of other pages. Indeed, the content which may be included as part of a website is almost limitless. For instance, textual content is still commonly used as the simplest way in which to communicate with the viewer.

E-commerce content, whether in the form of a shopping cart, single-click purchase, digital download and other content, is also commonly included, and may range from the simplest to the most complex of content.

Content in the form of web forms may also be used to capture viewer data such as an email address for inclusion in newsletter e-mailings or name/address information for regular mailings. Web forms are also convenient in that viewers may use them to complete a variety of tasks, such as joining particular programs (e.g., a sign up form for a rowing program), modifying previously entered and/or stored data (e.g., address information), and even electronically signing legal and other documents. Furthermore, web forms may be incorporated within a website in a variety of ways, whether as part of a web page or as their own separate page, depending on what best serves the needs of the website operator and/or viewer.

Furthermore, photo and image content is commonly included within a website not only to attract the viewers' attention, but as an effective way in which to communicate with viewers. Moreover, individuals and businesses are increasingly turning to the use of digital photos and images often storing and managing them online. As a result, website users and developers are faced with an increasing number of new and complex problems. For example, in addition to online storage, users are becoming accustomed to providing others with digital copies of their photos, whether via email or other means of communication. As a result, more and more websites and computer programs are providing users with photo management capabilities including, but not limited to, the ability to upload, store, manipulate, tag and forward photos and other images. Furthermore, as online and offline digital photo management gains in popularity, the number of features offered to users will only increase. However, as the capabilities of photo management systems increase, not only will the complexity of providing such capabilities increase, but users' expectations will also increase with respect to available features and their ease of use, especially in the online environment.

Nevertheless, traditional content management techniques are inconsistent with today's complexity as well as users' expectations. For example, websites have been traditionally created using simple text editing software. This ‘do-it-yourself’ development environment requires the designer to know a plethora of hypertext markup language symbols and techniques that are beyond the skill and interests of an average computer user. The storage, display and management of photos and other images only increases the necessary skill level.

However, nowadays more sophisticated web designing tools are available for the creation of websites. This component development environment provides the professional designer with the ability to create complex websites. These websites might enable and/or require the integration of modules for ecommerce, data entry, web statistics, site security, video, downloads, forms, photo/image management and others. To further complicate matters, the professional must also deal with website support services such as hosting, domain name, bandwidth, storage and email.

These two content management approaches are mastered through lots of training and skill. These tools are geared towards power users and fundamentally fail to guide a user through the simplest of tasks. This lack of guidance not only makes it difficult for the user to manage even the simplest of content, but the creation and management of more complex content such as e-commerce and photo content is beyond the capabilities of most users.

Despite these problems, little assistance is available to the user with respect to content management. Even less guidance is available to users managing complex content, such as web form, photo or e-commerce content.

Accordingly, there is a need for improvement with respect to content management, in both the online and offline environment. There is especially a need for improvement in the management of complex content such as web forms, photos and e-commerce content, without overwhelming the user with complexity.

### SUMMARY OF THE INVENTION

According to a preferred embodiment, the present invention generally relates to an interface tool for content management, said tool comprising: an interface for presenting a user with a layout comprising at least one content management module; the at least one content management module enabling a user to provide a desired content within the layout; the at least one content management module enabling management of the content.

According to another preferred embodiment, the present invention generally relates to a method for managing content, said method comprising: providing a user with a layout comprising at least one content management module; managing content via the at least one content management module; providing content within the layout via the at least one content management module.

According to another preferred embodiment, the present invention generally relates to a computer readable storage medium on which is embedded one or more computer programs, the one or more computer programs implementing a method for the management of content, the one or more computer programs comprising a set of instructions for: providing a user with a layout comprising at least one content management module; managing content via the at least one content management module; providing content within the layout via the at least one content management module.

### BRIEF DESCRIPTION OF THE DRAWINGS

Examples of the invention are illustrated, without limitation, in the accompanying figures in which like numeral references refer to like elements, and wherein:

FIG. 1 shows an interface for providing a layout, in accordance with a preferred embodiment of the present invention.

FIG. 2 shows an interface for providing a layout, in accordance with a preferred embodiment of the present invention.

FIG. 3 shows an interface for providing a layout, in accordance with a preferred embodiment of the present invention.

FIG. 4 shows an interface for providing a web form, in accordance with a preferred embodiment of the present invention.

FIG. 5 shows a technical design, in accordance with a preferred embodiment of the present invention.

FIG. 6 shows exemplary user instructions, in accordance with a preferred embodiment of the present invention.

FIG. 7 shows a template structure, in accordance with a preferred embodiment of the present invention.

FIG. 8 shows a template structure, in accordance with a preferred embodiment of the present invention.

FIG. 9 shows page control, in accordance with a preferred embodiment of the present invention.

FIG. 10 shows an interface for providing a layout of a web form, in accordance with a preferred embodiment of the present invention.

FIG. 11 shows an interface comprising a design space, in accordance with the preferred embodiment of FIG. 10.

FIG. 12 shows an interface displaying a text element in the design space, in accordance with the preferred embodiment of FIGS. 10 and 11.

FIG. 13 shows an interface for display of an input object, in accordance with the preferred embodiment of FIGS. 10, 11 and 12.

FIG. 14 shows an interface for providing a layout of a web form, in accordance with another preferred embodiment of the present invention.

FIG. 15 shows an interface displaying a text element in the design space, in accordance with the preferred embodiment of FIG. 14.

FIG. 16 shows an interface for display of an input object, in accordance with the preferred embodiment of FIGS. 14 and 15.

FIG. 17 shows an interface for providing a layout of a web form, in accordance with another preferred embodiment of the present invention.

FIG. 18 shows an interface displaying a text element in the design space, in accordance with the preferred embodiment of FIG. 17.

FIG. 19 shows an interface for display of an input object, in accordance with the preferred embodiment of FIGS. 17 and 18.

FIG. 20 shows a web view of a built web form, in accordance with the preferred embodiment of FIGS. 17, 18 and 19

FIG. 21 shows a report for displaying data captured via a web form built in accordance with a preferred embodiment of the present invention.

FIG. 22 shows a technical design, in accordance with a preferred embodiment of the present invention.

FIG. 23 shows a form library, in accordance with a preferred embodiment of the present invention.

FIG. 24 shows a parsing tool, in accordance with a preferred embodiment of the present invention.

FIG. 25 shows an interface for providing a layout with a plurality of photo boxes and text boxes, in accordance with a preferred embodiment of the present invention.

FIG. 26 shows an interface for providing a photo manager, in accordance with a preferred embodiment of the present invention.

FIG. 27 shows an interface for providing a photo manager, in accordance with a preferred embodiment of the present invention.

FIG. 28 shows an interface for providing a photo manager, in accordance with the preferred embodiment of the present invention.

FIG. 29 shows an interface for providing a photo manager, in accordance with another preferred embodiment of the present invention.

FIG. 30 shows an interface for providing photo manager, in accordance with the preferred embodiment of the present invention.

FIG. 31 shows an interface for providing a photo manager, in accordance with a preferred embodiment of the present invention.

FIG. 32 shows an interface for providing a layout, in accordance with a preferred embodiment of the present invention.

FIG. 33 shows an interface for providing a photo manager, in accordance with a preferred embodiment of the present invention.

FIG. 34 shows an interface for providing a photo manager, in accordance with a preferred embodiment of the present invention.

FIG. 35 shows an interface for providing a photo manager, in accordance with a preferred embodiment of the present invention.

FIG. 36 shows an interface for providing a layout, in accordance with a preferred embodiment of the present invention.

FIG. 37 shows an interface for providing a photo manager, in accordance with a preferred embodiment of the present invention.

FIG. 38 shows an interface for providing a photo manager, in accordance with a preferred embodiment of the present invention.

FIG. 39 shows an interface for providing a layout, in accordance with a preferred embodiment of the present invention.

FIG. 40 shows a technical design, in accordance with a preferred embodiment of the present invention.

FIG. 41 shows a photo box, in accordance with a preferred embodiment of the present invention.

FIG. 42 shows a block diagram of a computer system wherein preferred embodiments of the present invention may be implemented.

### DETAILED DESCRIPTION OF THE PREFERRED EMBODIMENTS

For simplicity and illustrative purposes, the principles are shown by way of examples of systems and methods described. In the following description, numerous specific details are set forth in order to provide a thorough understanding of the examples. It will be apparent however, to one of ordinary skill in the art, that the examples may be practiced without limitation to these specific details. In other instances, well known methods and structures are not described in detail so as not to unnecessarily obscure understanding of the examples.

The present invention relates to tools, methods, and/or computer software applications for content management. The present invention preferably relates to tools, methods, and/or computer software applications for the management of content including, but not limited to, text, photos or images, web forms and e-commerce content. In one example, the tools, methods, and/or computer software applications include an interface 100 providing a user with a layout 110 comprising at least one content management module 10. Preferably, the tools, methods, and/or computer software applications include the at least one content management module 10 enabling a user to provide a desired content within the layout 110. More preferably, the tools, methods, and/or computer software applications include the at least one content management module 10 enabling management of the content.

Throughout the present disclosure, reference is made to an interface (or user interface) 100. An interface 100 is a tool through which the user may interact with any element(s) of the present invention. Preferably, the interface 100 is a screen displayed within a computer application or web browser for interaction with elements of the present invention. In one example, the interface 100 is a screen through which the user may select or create a layout 110 for a web form 400, as illustrated throughout the drawings and discussed herein. In another example, the interface 100 is a screen through which the user may enter a text element 200, as illustrated throughout the drawings and discussed herein. In another example, the interface 100 is a screen through which the user may manager photos or images, as illustrated throughout the drawings and discussed herein. Those of ordinary skill in the art will recognize that an interface 100 may be embodied by a computer program or a plurality of computer programs, which may exist in a variety of forms both active and inactive in a single computer system or across multiple computer systems.

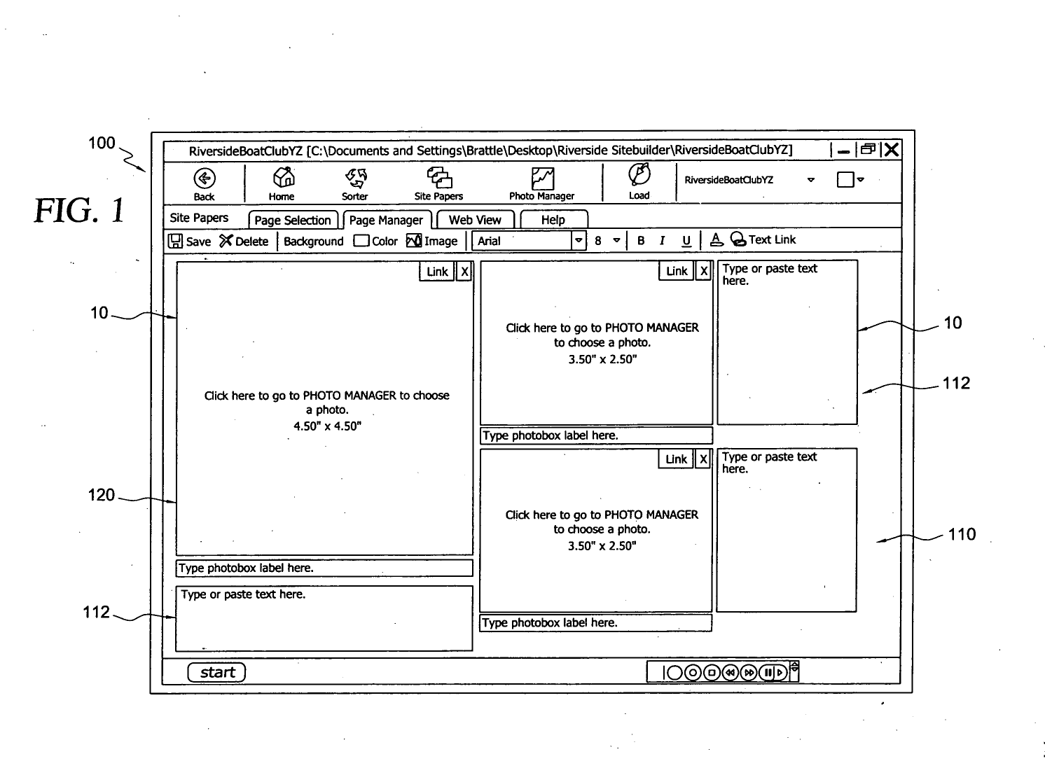

Throughout the present disclosure, reference is made to a content management module 10. With reference to FIGS. 1-4, a content management module 10 may be explained as means enabling a user to provide a desired content within a layout 110. A content management module 10 may also be explained as means enabling a user to manage content. Those of ordinary skill in the art will recognize the phrase “manage” to include the adding, editing and/or other manipulation of content. In one exemplary embodiment, a content management module 10 enables a user to provide and/or manage textual (e.g., plain text) content. Preferably, the content management module 10 is a text box 112. In another exemplary embodiment, a content management module 10 enables a user to provide and/or manage web form content, including the web form 400 itself. In another exemplary embodiment, a content management module 10 enables a user to provide and/or manage photos and/or images. Preferably, the content management module 10 is a photo box 120. In another exemplary embodiment, a content management module 10 enables a user to provide and/or manage e-commerce content, for example to provide e-commerce capability within a layout 110. Preferably, the content management module 10 is an e-commerce box 130.

In one example, the present invention relates to an interface tool for content management. The interface tool includes an interface 100 for presenting a user with a layout 110 comprising at least one content management module 10. The interface tool includes the at least one content management module 10 enabling a user to provide a desired content within the layout 110. The interface tool also includes the least one content management module 10 enabling management of the content. In one exemplary embodiment, the interface tool includes means for assembling a page (e.g., web page) based on the layout 110 and content provided via the at least one content management module. In another exemplary embodiment, the layout 110 is selectable from a plurality of prescribed layouts. In another exemplary embodiment, the layout 110 includes a plurality of content management modules 10.

In another example, the present invention relates to a method for managing content. The method includes providing a user with a layout 110 comprising at least one content management module 10. The method includes managing content via the at least one content management module 10. The method also includes providing content within the layout 110 via the at least one content management module 10. In one exemplary embodiment, the method includes assembling a page based on the layout 110 and content provided via the at least one content management module 10. In another exemplary embodiment, the method includes selecting the layout 110 from a plurality of prescribed layouts. In another exemplary embodiment, the method includes the layout 110 including a plurality of content management modules 10.

In another example, the present invention relates to a computer readable storage medium on which is embedded one or more computer programs, the one or more computer programs implementing a method for the management of content. The one or more computer programs include a set of instructions for providing a user with a layout 110 comprising at least one content management module 10. The one or more computer programs include a set of instructions for managing content via the at least one content management module 10. The one or more computer programs also include a set of instructions for providing content within the layout 110 via the at least one content management module 10.

As will be apparent from the discussion below and the accompanying drawings, the tools, methods and/or computer applications enable the management of different types of content. In one exemplary embodiment, the present invention provides an interface 100 which provides access to a layout 110 comprising content management modules 10 enabling a user to provide and/or manage textual (e.g., plain text) content. As shown in FIGS. 1-4, the content management modules 10 may be (or provide access to) a text box 112 through which the user may enter (e.g., type of paste) and display text.

In another exemplary embodiment, the present invention provides an interface which includes a content management module 10 enabling a user to provide and/or manage a web form 400. The content management module 10 may be a module for managing (e.g., creating, editing, etc.) a web form. In one example, as discussed in more detail below, the content management module 10 enables user access to a Forms Manager 500 as discussed below. The content management module 10 preferably enables managing a web form 400 by enabling access to a user interface 110 comprising a design space 510, the user interface 100 providing for the user to enter at least one text element 200 in the design space 510; and a parsing tool for translation of the at least one text element 200 into at least one input object 300 for the web form 400.

In another exemplary embodiment, the present invention provides an interface which includes a content management module 10 enabling a user to manage photos and/or images. The content management module 10 may be a module for managing (e.g., composing, resizing, cropping) a photo or image. In one example, as shown in FIGS. 1-3, the content management module 10 may comprise a photo box 120 for the management of photos. As discussed in more detail below, the photo box 120 preferably provides access to a user interface 100 comprising a photo manager 2000 comprising an image editor 2100 and a resize tool 2200; the image editor 2100 having a defined boundary 3100 and superimposable over a photo; and a resize tool 2200 providing for resizing at least a section of the photo within the defined boundary 3100 of the image editor 2100. In one exemplary embodiment, the image editor 2100 is movable over the photo so that a desired section of the photo rests within the defined boundary 3100 of the image editor 2100. In another exemplary embodiment, the photo manager 2000 includes a cropping tool 2300 for cropping the photo as defined by the boundary 3100 of the image editor 2100.

In another exemplary embodiment, the present invention provides an interface which includes a content management module 10 enabling a user to provide and/or manage e-commerce content. For example, the content management module 10 may comprise an e-commerce box 130 enabling the e-commerce capability within the page. In one example, the e-commerce box 130 may enable a listing tool for the listing of products or services. In another example, the e-commerce box may provide for a shopping cart, through which e-commerce capability may be implemented.

With reference to the drawings described herein, those of ordinary skill in the art will recognize that the present invention generally relates to improved tools, methods and/or computer programs for the management of different types of content within a layout 110, for example a layout 110 for a web such as a web page. Through the present invention, the user with limited knowledge of computers, computer software, web design or even the content at issue may effectively manage different types of content, including the loading, modifying and/or displaying of content, in both the online and offline environment.

As illustrated in the exemplary embodiment of FIG. 1, an interface 100 provides the user with a layout 110 comprising a plurality of content management modules 10. However, in one example, the user is provided with the capability of creating a “custom” layout 110. Those of ordinary skill in the art will recognize that the layout 110 is preferably customizable; that is, the interface 100 allows the user to create a “custom” layout 110. For instance, in accordance with preferred embodiments, the user may be provided with a blank or empty layout 110 along with the means for locating content management modules 10 (e.g., text box 112, photo box 120, e-commerce box 130, etc.) within the layout 110 wherever the user so chooses. Those of ordinary skill in the art will recognize that the user may be provided with a variety of means for customizing a layout 110, such as a control tool located within a tool bar. Those of ordinary skill in the art will also recognize that a control tool may be in the form of various preferred embodiments, for instance a drawing tool or a select-and-drag tool which allows the user with the option of drawing or selecting-and-dragging content management modules 10 within a layout 110 in a “custom” configuration.

In another example, the interface 100 is selected from a plurality of prescribed layouts. As shown in FIG. 1, the layout 100 may include at least one text box 112 in which the user may enter (e.g., type of paste) and display text. The layout 100 may include a plurality of text boxes 112 of varying size. The layout 100 may include at least one photo box 120, including a plurality of photo boxes 120, of varying size. The photo box 120 preferably enables the management of photos and other images via access to a photo manager 2000. A photo manager 2000 is discussed in further detail below. Preferably, a photo manager 2000 is accessed via a photo box 120, preferably by clicking (e.g., with a computer mouse) on the photo box 120. Those of ordinary skill in the art will recognize that through the interface 100 of FIG. 1, a user may choose to access some or all of the content management modules 10 provided within the layout 110, thereby creating a layout 110 comprising only the content desired.

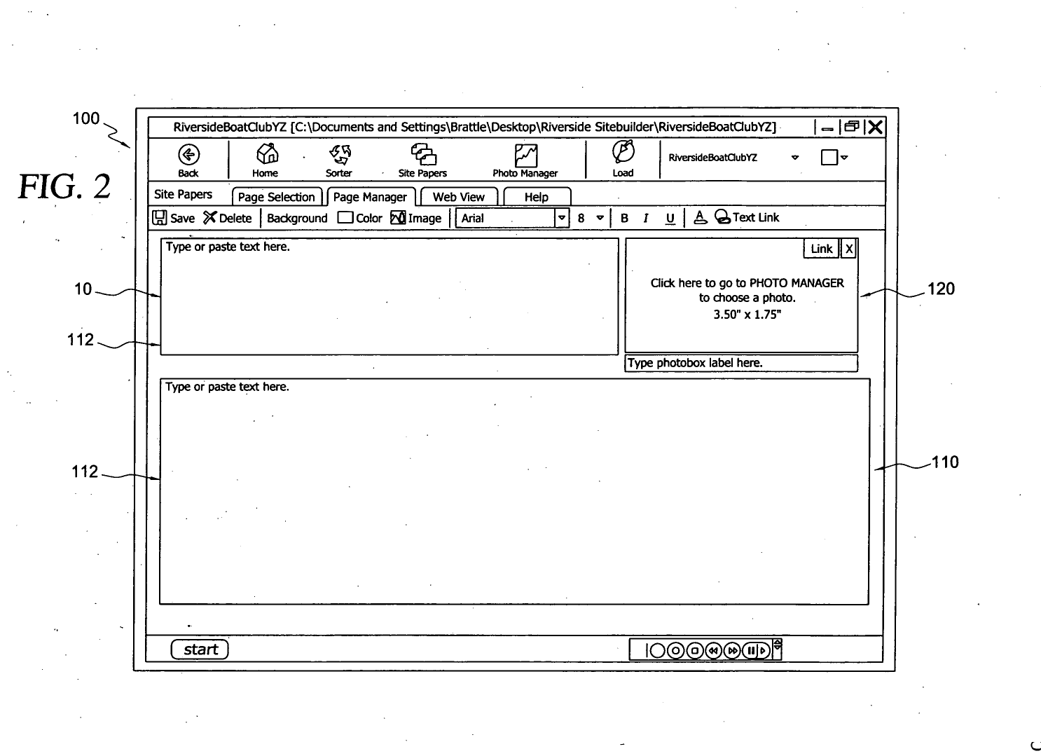

As illustrated in exemplary embodiment of FIG. 2, an interface 100 provides the user with a layout 110 comprising a plurality of content management modules 10, wherein the layout 110 is different from that shown in FIG. 1. Those of ordinary skill in the art will recognize that the present invention preferably provides the user with a number of layouts 110 for selection, thereby providing the user with a variety of layout design. Those of ordinary skill in the art will recognize that the present invention preferably provides the user with a number of different types of content management modules 10 that may be accessed by the user, thereby providing the user with the ability to select the type of content that will be provided within the layout 110. For example, as shown in the example of FIG. 2, the layout 110 may include a plurality of text boxes 112 of varying size in which a user may enter (e.g., type or paste) and display text. The layout 110 may also include a photo box 120, through which the user may access a photo manager 200 for the management of photos and other images, as discussed in further detail below.

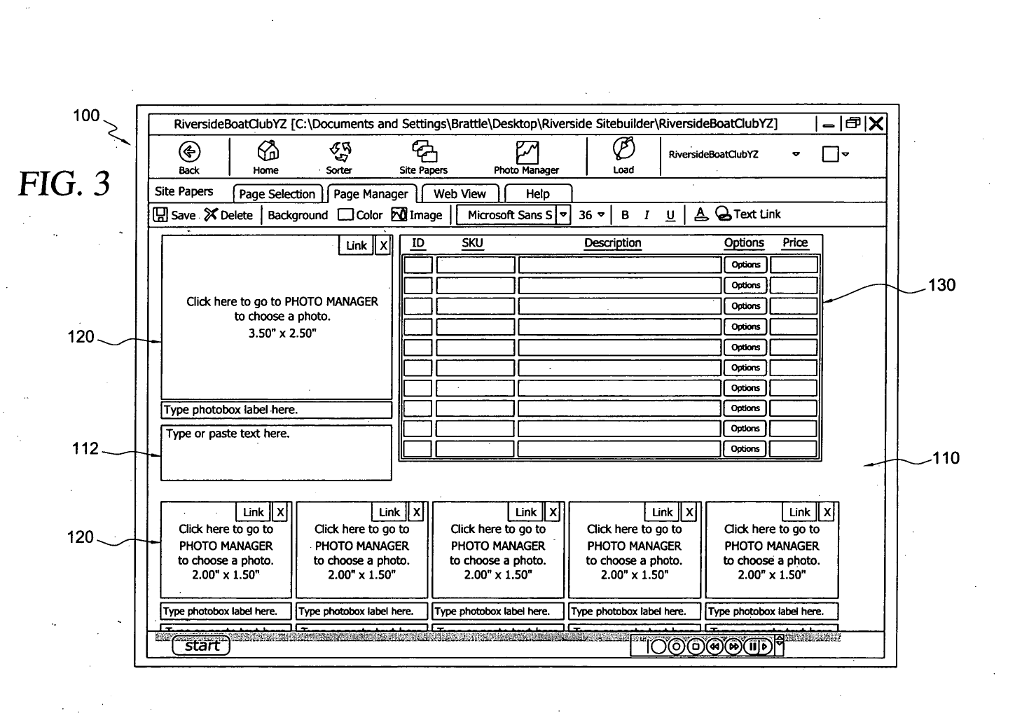

As illustrated in exemplary embodiment of FIG. 3, an interface 100 provides the user with a layout 110 comprising a combination of content management modules 10 for the management of text, photo and e-commerce content. Along with photo boxes 120 and text boxes 112, the layout 110 may include an e-commerce box 130. Those of ordinary skill in the art will recognize that the e-commerce box 130 preferably provides access to product or service data. Preferably, the e-commerce box 130 content includes built-in product or service options, and product or service listing tools. Those of ordinary skill in the art will recognize that such content management modules 10 and their associated tools facilitate e-commerce page creation by the user.

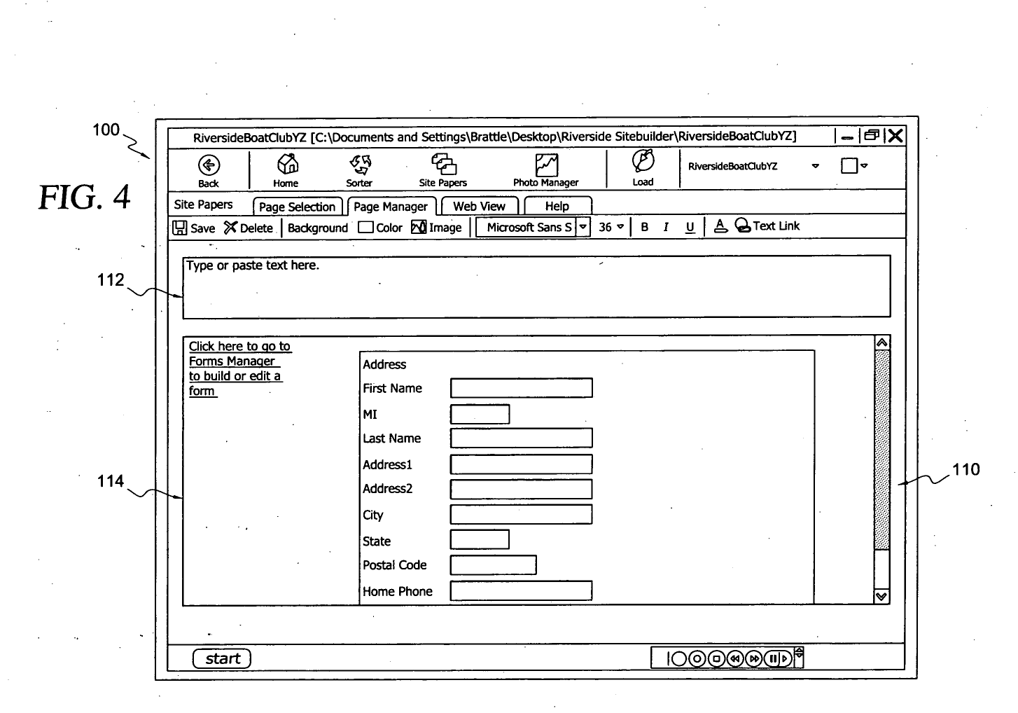

As illustrated in exemplary embodiment of FIG. 4, an interface 100 provides the user with access to a layout 110 for creating a web form 400, wherein the layout 110 may be accessed from the Forms Manager 500 discussed in detail below. In view of FIG. 4 and FIGS. 1-3 discussed above, those of ordinary skill in the art will recognize that an interface may provide a use with access to a layout 110 comprising content management modules 10 for managing different types of content. A content management module 10 may provide for the management of a web form 400. In one exemplary embodiment of the present invention, the content management module 10 enables management of a web form 400 by providing user access to a Forms Manager 500 as discussed below. Preferably, the content management module 10 enables access to a user interface 110 comprising a design space 510, wherein the user may enter at least one text element 200 in the design space 510; and a parsing tool for translation of the at least one text element 200 into at least one input object 300 for the web form 400.

Those of ordinary skill in the art will recognize that in accordance with the exemplary embodiments, the present invention may encompass publication of the layout 110 including the content provided and/or managed therein. Preferably, the present invention includes means for assembling a page based on the layout 110 and content provided therein via at least one content management module 10. For example, the present invention may include means for assembling and publishing the layout 110 to the Internet, as a web page or part of a web page. Such publication tools are well within the skill of those of ordinary skill in the art. In another example, the present invention includes means for assembling the layout 110 and publishing the layout 110 by printing with a printer. Those of ordinary skill in the art will recognize that any number of assembly and publication means may be encompassed by the present invention.

Those of ordinary skill in the art will also recognize, especially in view of FIG. 1, that the interface 100 preferably provides the user with what is known in the art as What You See Is What You Get (“WYSWYG”). That is, the interface 100 preferably provides the user with a view of the layout 110 as it would appear if finished or published at that moment, even though the layout 110 remains under construction. In other words, in accordance with preferred embodiments of the present invention, the user is preferably provided with a view of the layout 110 as it would appear if published at that moment, as shown for instance in FIG. 1, without having to actually undergo additional steps such as publication as typically required. Those of ordinary skill in the art will recognize that such WYSWYG capability greatly simplifies the process of building pages (e.g., a web page) via a layout 110.

Technical Design Overview

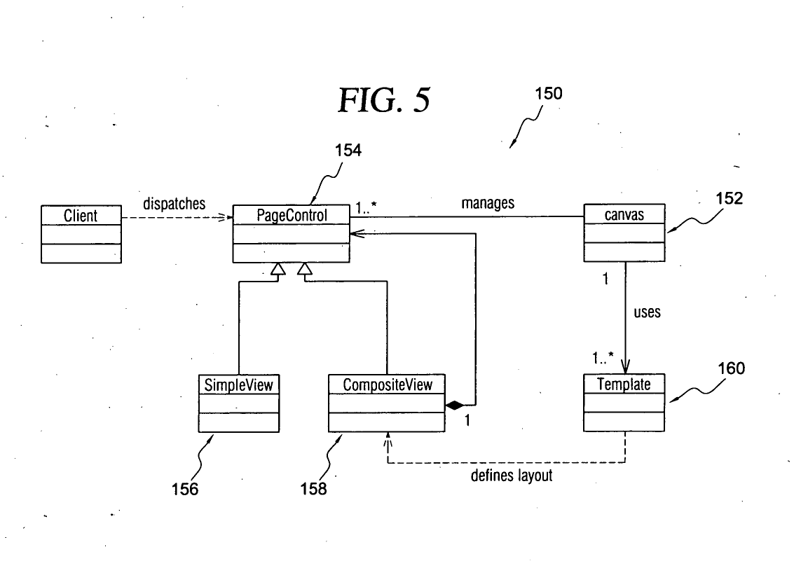

With respect to the technical design, the interface tools, methods and/or computer programs of the present invention may employ any number of preferred embodiments. For example, those of ordinary skill in the art will recognize that a preferred technical design 150 of the present invention may be illustrated by FIG. 5. In the example of FIG. 5, a canvas 152 manages a set of PageControls 154 which contains either a simple view 156 or a composite view 158. In this example, a simple view 156 may be defined as a single window-based control, whereas a composite view 158 may be defined as composed of multiple window-based controls and PageControls 154. The canvas 152 which determines layout 110 and content type, preferably obtains layout 110 information from a Template 160. Based on a given canvas 152 size, the canvas 152 dynamically calculates the position of each content management module 10 within a layout 110.

Those of ordinary skill in the art will recognize a PageControl 154 class as an abstract class from which all components of a page (e.g., a page forming a layout 110) may be derived. A PageControl 154 is preferably associated with a TemplateComponent 196, which contains information about layout 110 and size. When the user inputs content into the Template Component 196, the component then saves the content into a corresponding PageItem object (not shown). During a save, the PageItems (not shown) from each Template Component 196 is collected to form a page. Those of ordinary skill in the art will recognize a canvas 152 as a collection of PageControls 154, a Template 160 as a collection of TemplateComponents 196 and a page as a collection of PageItems (not shown).

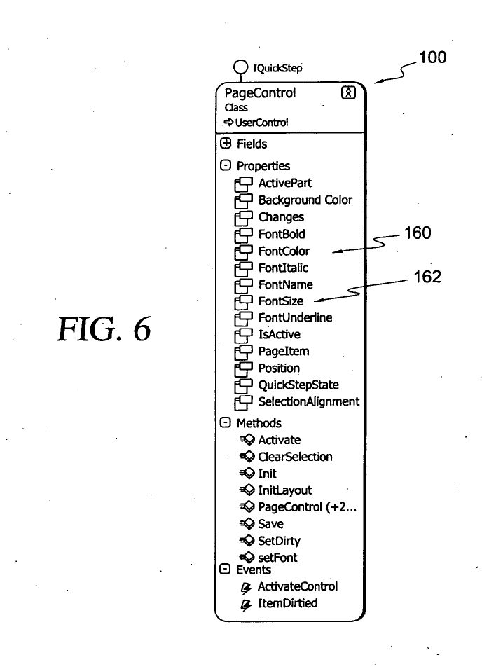

Those of ordinary skill in the art will recognize FIG. 6 as illustrating an interface 100 which may be provided to a user and containing tools for the management of a layout 110 and the content management modules 10 included therein. For instance, an interface 100 as shown in FIG. 6 may include tools for managing Font Color 160, Font Size 162 along with numerous other content management tools.

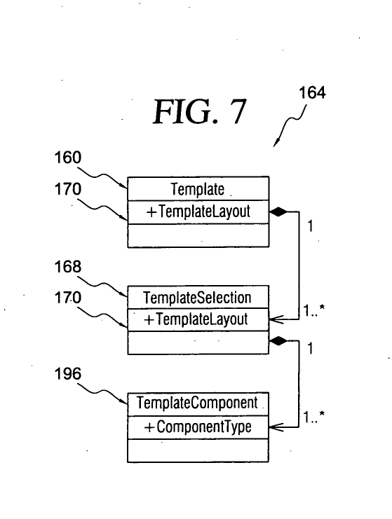

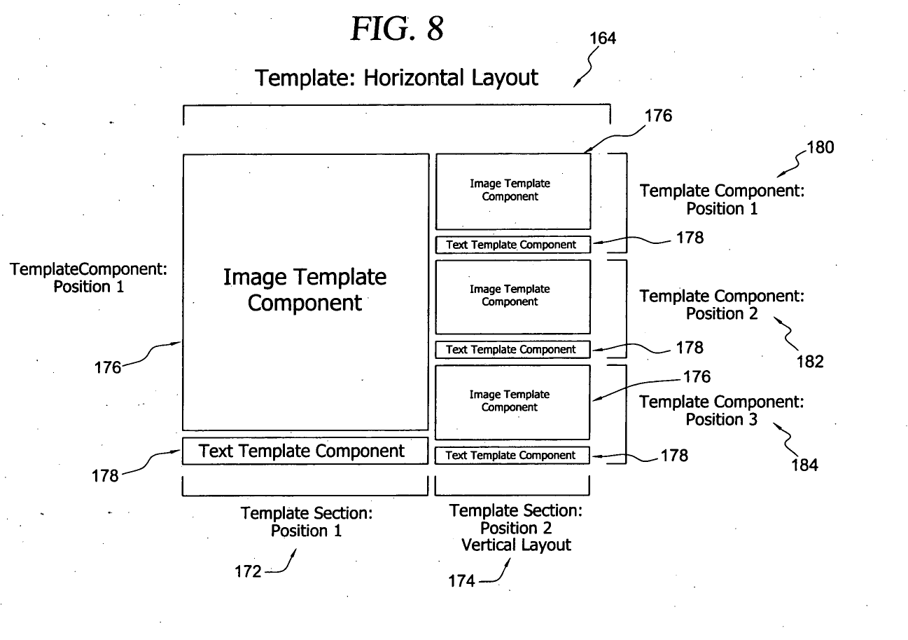

Those of ordinary skill in the art will recognize FIGS. 7 and 8 as illustrating template structure 164 in accordance with exemplary embodiments of the present invention. With reference to FIG. 7, those of ordinary skill in the art will recognize the template structure 164 as containing data about the layout 110 and content of the canvas 152. In this example, both the Template 160 and TemplateSection 168 contain the property TemplateLayout 170 for determining whether to arrange components vertically or horizontally.

The example of FIG. 8 shows a template structure 164 with a horizontal layout which includes two TemplateSections (TemplateSection: position one (1) 172 and TemplateSection: position two (2) 174). TemplateSection: position one (1) 172 contains Image 176 and Text 178 Template Components. TemplateSection: position two (2) 174 contains TemplateComponent: Position one (1) 180, TemplateComponent: Position two (2) 182 and TemplateComponent: Position three (3) 184, each of which also contains Image 176 and Text 178 Template Components laid out vertically.

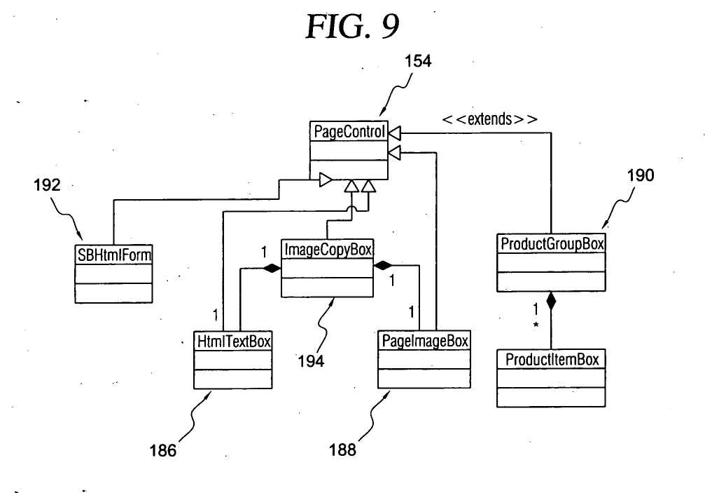

Those of ordinary skill in the art will recognize FIG. 9 as illustrating PageControl 154 in accordance with exemplary embodiments of the present invention. In this example, there is a one-to-one relation to a website component and a Site Builder's Composite View. The HtmlTextBox 186 is an editor for pure text. The PageImageBox 188 is an editor for an image. The ProductGroupBox 190 is an input editor for e-commerce items. The SBHtmlForm 192 is an editor for HtmlForms (not shown). The ImageCopyBox 194 is a composite of HtmlTextBox 186 and PageImageBox 188. Those of ordinary skill in the art will recognize that the addition of web components, such as a calendar, blog and so on only requires addition on a PageControl 154 editor.

Web Forms Creation and Reporting Tool

The present invention relates to user interface tools, methods and computer programs for creating web pages (e.g., web forms). The interface tools, methods and computer programs of the present invention provide the user with at least one interface 100 through which the layout 110 and design of the web page 400 may be selected or created by the user. The interface tools, methods and computer programs of the present invention allow a user to create a web page 400 via simple text elements 200, preferably the entering of text elements 200 in a design space 510 accessible through a user interface 100. The interface tools, methods and computer programs of the present invention also provide a parsing tool for the translation of text elements 200 into input objects 300 for a web page 400. Those of ordinary skill in the art will recognize that through the use of simple text elements 200 and their parsing into input objects 300, the interface tools, methods and computer programs of the present invention provide the user with an improved and simplified technique with which to create and build complex web pages such as web forms 400.

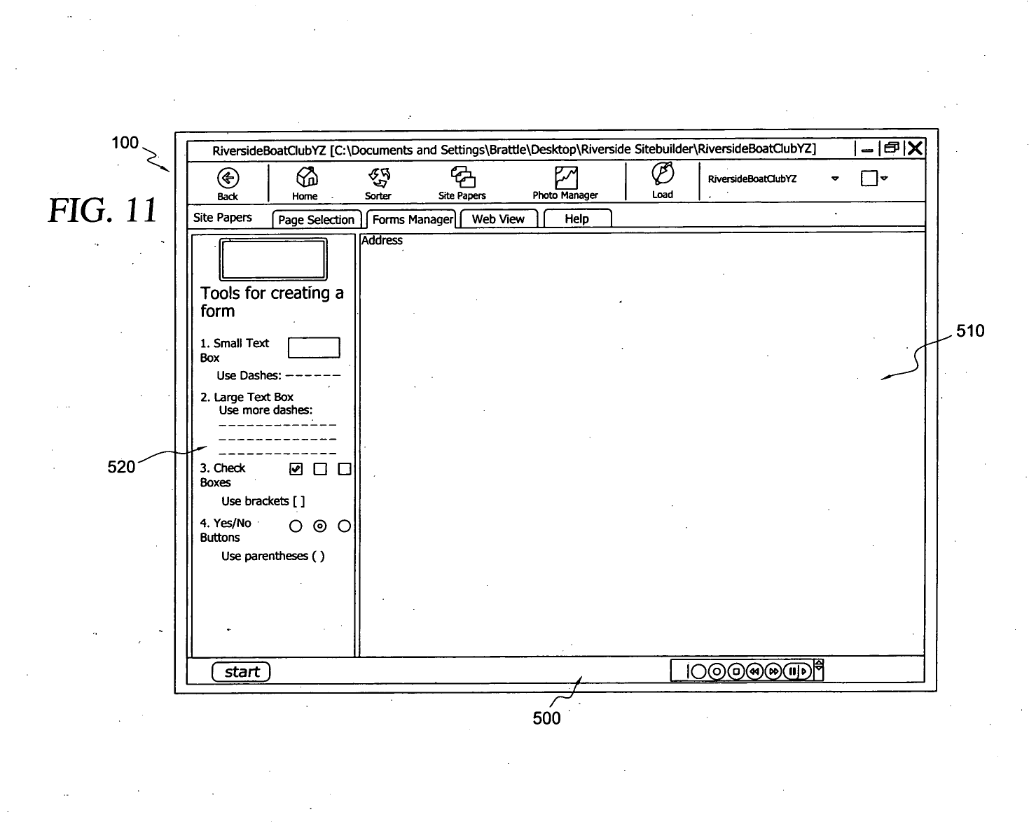

Throughout the present disclosure, reference is made to text elements 200. A text element 200 is any standard text character that may be entered by the user and translated by a parser in accordance with the present invention. Preferably, the standard text character is translated into an input object 300 in accordance with the present invention. Put another way, in a preferred embodiment, the standard text character serves as a representation of an input object 300, wherein the standard text character may be parsed or translated into the input object 300. In one example, the text element 200 comprises dashes 210, 220, as shown in FIGS. 11, 12, 15 and 18, wherein the dashes 210, 220 represent and are parsed into a text box 310, 320 (input object) for a web form 400. In another example, the text element 200 comprises brackets 230, as shown in FIGS. 11, 12, 15 and 18, wherein brackets 230 represent and are translated into a check box 330 (input object) for a web form 400. In another example, the text element 200 comprises parentheses 240, as shown in FIGS. 11, 12, 15 and 18, wherein the parentheses 240 represent and are translated into yes/no buttons 340 (input object) for a web form 400.

Throughout the present disclosure, reference is made to a parsing tool (or parser). A parsing tool may be any application (e.g., computer program or instructions) that translates a text element 200 into an input object 300. Preferably, the parsing tool translates a text element 200 into an input object 300, wherein the input object 300 is then included as part of a web form 400. In one example, the parsing tool comprises software instructions for translating a text element 200 into an input object 300, preferably as part of a web form 400.

Throughout the present disclosure, reference is made to an input object 300. An input object 300 is any means which allows a viewer or user of a page to input data and/or information. An input object 300 may also be referred to as an input field, for example a text box or field 310, 320, check box 330, yes/no buttons 340 or drop-down box (not shown). Preferably, the input object 300 is included as part of a web form 400 which may be published, for example in an Internet browser. In one example, the input object 300 is a text box 310, 320 for a web form 400. In another example, the input object 300 is a check box 330 for a web form 400. In another example, the input object 300 is yes/no buttons 340 for a web form 400.

Those of ordinary skill in the art will recognize that the present invention generally relates to improved tools, methods and computer software programs for building a web page, in particular a web form 400. In the present invention, the user (e.g., website or web form builder) with limited knowledge of web design may create the input objects or fields 300 that make up a web form 400 or parts of a web page. The user is provided with the tools to create the input objects 300 through the use of text elements 200. As discussed above, a text element 200 may be translated by a parsing tool into an input object 300 and preferably displayed as part of a web form 400. Preferably, the user creates a web form 400 by entering a text element(s) 200 within the design space 510 accessed through a user interface 100, wherein a parsing tool translates the text elements 200 into input objects 300 as part of a web form 400.

In one example, the present invention includes text elements 200, thereby allowing users to quickly and simply create complex web pages including web forms 400. Previously, such text elements 200 were not available to users for the creation of web pages and, as a result, it was necessary to for users to learn and utilize complex skills and tools when creating web pages such as web forms 400. In accordance with preferred embodiments of the present invention, however, users are now able create forms 400 with simple text elements 200. Rather than having to learn complex skills, the simplicity of text elements 200 allows the user to create web pages with little more than a user interface 100 and limited instruction, for instance as shown in FIGS. 11, 12, 15 and 18.

In another example, the present invention also includes a parsing tool, which may be used to translate (or parse) the text elements 200 into input objects 300. Preferably, the parsing tool is comprised of software instructions, so that the user need not learn how to use or even be aware of the parsing tool. The parsing tool may be embodied within the various examples of the present invention. Preferably, the parsing tool automatically converts text elements 200 to input objects 300 as the user employs the interface 100 tools and methods of the present invention. Put another way, the translation function of the parsing tool may be automatically activated as the user navigates the interface 100 tools and methods of the present invention. A preferred embodiment of the parsing tool is described in detail below.

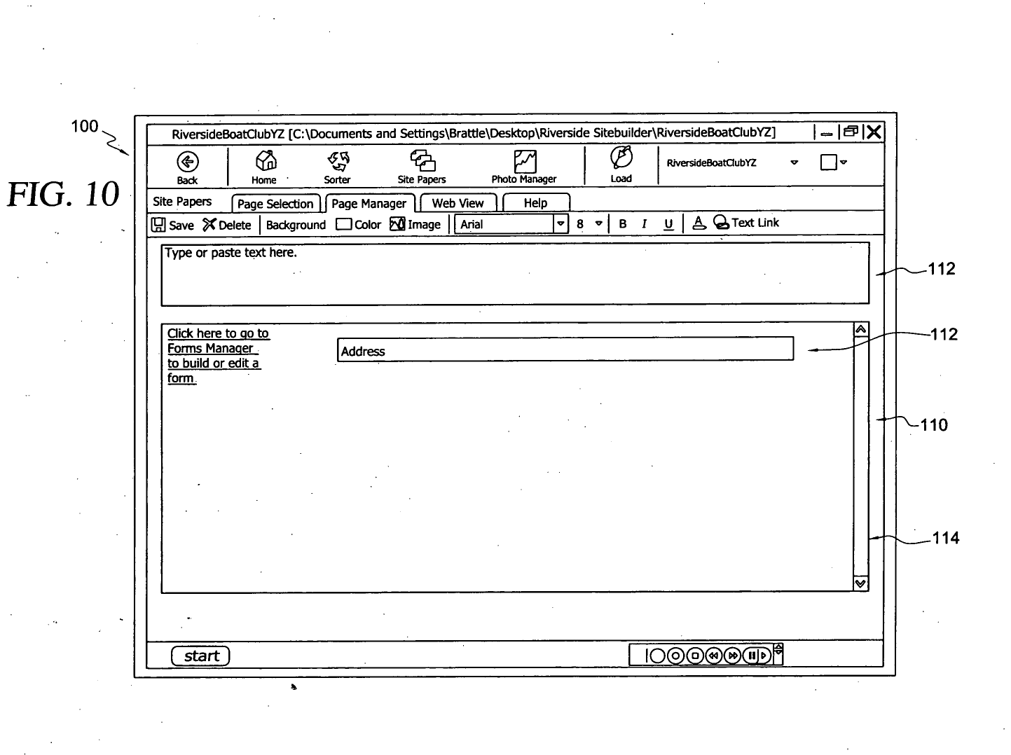

In one preferred embodiment, discussed with reference to FIGS. 10-13, the present invention encompasses a tool, method and/or computer programs through which the user may build a web form 400. For example, as illustrated in FIG. 10, the user accesses an interface 100 executed for instance within a computer application or an Internet browser (e.g., Internet Explorer). In one example, the interface 100 allows the user to create a layout 110 for a web form 400. That is, in accordance with preferred embodiments of the present invention, the user may be provided with a blank layout 110 along with the means for locating the web form and/or or elements of the web form within the layout 110 wherever the user so chooses. Those of ordinary skill in the art will recognize that the user may be provided with a variety of means for customizing a layout 110, such as a control tool located within a tool bar. Those of ordinary skill in the art will also recognize that a control tool may be in the form of various preferred embodiments, for instance a drawing tool or a select-and-drag tool which allows the user with the option of providing the elements of a web form 400 within a layout 110 in a “custom” configuration.

In another example, the interface 100 includes at least one prescribed layout 110 for a web form 400, wherein the user may select a layout 110 from those provided. As illustrated in FIG. 10, an example prescribed layout 110 includes a smaller, upper text box 112 and a larger, lower forms box 114. Within the upper text box 112, the user may enter (e.g., type or paste) text. In this example, the lower forms box 114 also includes a text box 112 in which the user enters (e.g., types or pastes) text. The lower forms box 114 preferably allows the user to begin building a web form 400. For example, in this example, the lower forms box 114 allows the user to access the Forms Manager 500, in this instance via a text link (“Click here to go to Forms Manager to build or add a form”), wherein the user may build the web form 400.

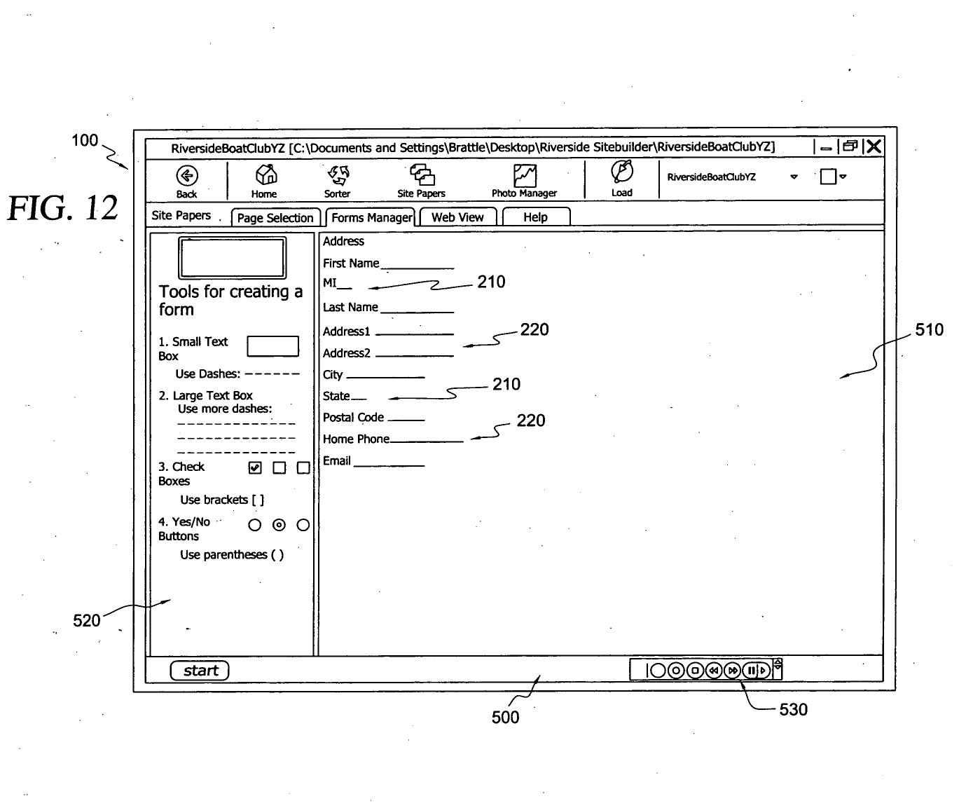

As illustrated in FIGS. 11 and 12, an interface 100 provides the user with access to the Forms Manager 500. The Forms Manager 500 preferably enables the use of at least one text element 200 which may be used to produce an input object 300 for a web form 400. The Forms Manager 500 preferably includes a design space 510 for the building of the web form 400 with text elements 200. Preferably, the Forms Manager 500 includes an instruction space (e.g., containing written instructions) 520 directing the user in the creation of a web form 400 with text elements 200. In one example, as illustrated in FIGS. 11 and 12, the instructions space 520 may inform that user that text element 200 of dashes, ------ 210, may be entered by the user in the design space 510 for creating a small text box 310 (input object). The instructions may also inform the user that a larger text box 320 (input object) may be created by entering a larger number of dashes, -------------- 220. The instructions 520 may also inform the user that a check box 330 (input object) may be created by entering the text element 200 of brackets 230, [ ], in the design space 510. The instructions 520 may further inform the user that yes/no buttons 340 (input object) may created by the user entering the text element 200 of parentheses 240, ( ), in the design space 510. Those of ordinary skill in the art will recognize that a variety of different text elements 200 and instructions 520 associated therewith may be included as part of the Forms Manager 500, for instance as illustrated in FIGS. 11 and 12.

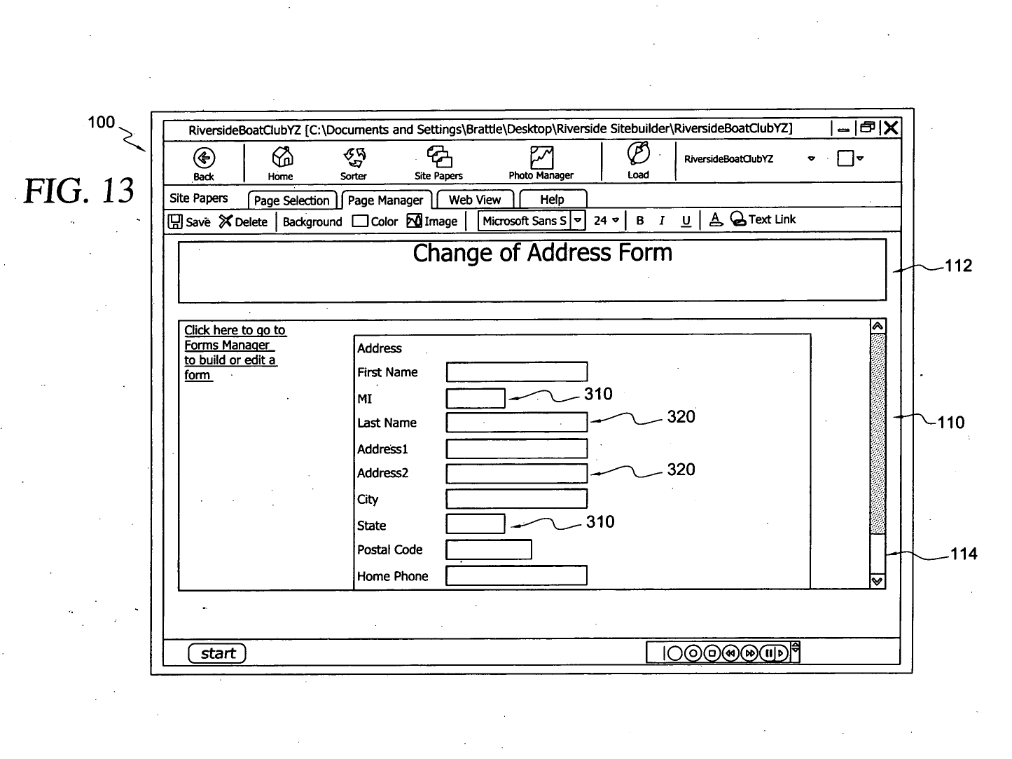

FIG. 12 further illustrates use of the text elements 200 within the design space 510 for creation of a web form 400 within the Forms Manager 500. As shown in FIG. 12, within the design space 510, the user has entered the text element of dashes 210, 220 to represent a text box 310, 320 (input object). As shown in FIG. 12, the user may vary the number of dashes 210, 220 so as to represent text boxes 310, 320 (input objects) of varying length. Those of ordinary skill in the art will recognize that by referring to a user entering a text element 200, it is meant that the user types, pastes or otherwise inserts a text element 200 within the design space 510, in accordance with the improved and simplified aspects of the present invention. Although not illustrated in FIG. 12, if so desired, the user may enter additional text elements 200 (e.g., brackets, parentheses) within the design space 510, for the creation of additional input objects 300 as part of the web form 400. As further illustrated by FIG. 12, the user is preferably provided with a save tool 530, so that this text element 200 representation of the web form 400, which may be referred to as a “draft” form, may be saved for further editing and so on. The user may also be provided with the option of placing the “draft” form within the forms box 114 of the layout 110 previously illustrated in FIG. 10, as is shown in FIG. 13.

As illustrated in FIG. 13, a user interface provides the user with the layout 110 including the upper, text box 112 and lower, forms box 114 as previously shown in FIG. 10. Those of ordinary skill in the art will recognize that the “draft” form of FIG. 12 has been placed within the lower, forms box 114. That is, those of ordinary skill in the art will recognize that the text elements 210, 220 shown in FIGS. 11 and 12 have been translated into the input objects 310, 320 of FIG. 13. A more detailed discussion of the parser for such translation is presented below. In this example, the lower, forms box 114 provides the user with the option of returning to the Forms Manager 500, via the text link (“Click here to go to Forms Manager to build or edit a form”), wherein the user may build another form or edit the current form. Furthermore, in this instance, the user has typed the phrase “Change of Address Form” within the upper, text box 112, thereby providing a title for this web form 400. Preferably, the user interface 100 also provides the user with a Web View of the created work. In other words, the interface 100 preferably provides a view of the web form 400 as it will appear once published to the Internet (i.e., the web). Furthermore, preferably the user is provided with the tools and/or methods to publish the created web form 400 to the Internet, preferably within an Internet browser.

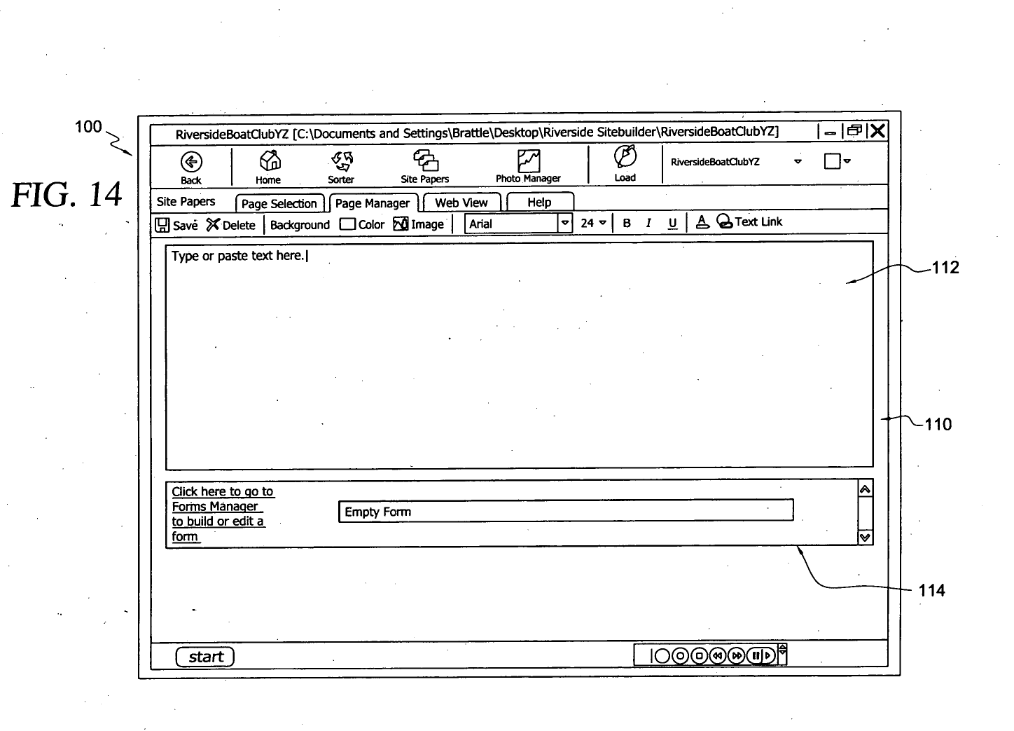

In another preferred embodiment, discussed with reference to FIGS. 14-16, the present invention encompasses a tool, method and/or computer programs through which the user may build a web form. As illustrated in FIG. 14, the user may access an interface 100 executed for instance within a computer application or an Internet browser. In one example, the selects a layout 110 for the web form 400 from a plurality of prescribed web form layouts 110. In another example, the use may create a custom layout 110 for the web form 400. As illustrated in FIG. 14, the prescribed layout includes a large, upper text box 112 and a small, lower forms box 114. Whereas the user may enter (e.g., type or paste) text within the upper text box 112, the lower forms box 114 preferably allows the user to begin building the web form 400. For example, the lower forms box 114 preferably allows the user to access the Forms Manager 500, in this instance via a text link (“Click here to go to Forms Manager to build or edit a form”), wherein the user may build or edit the web form 400.

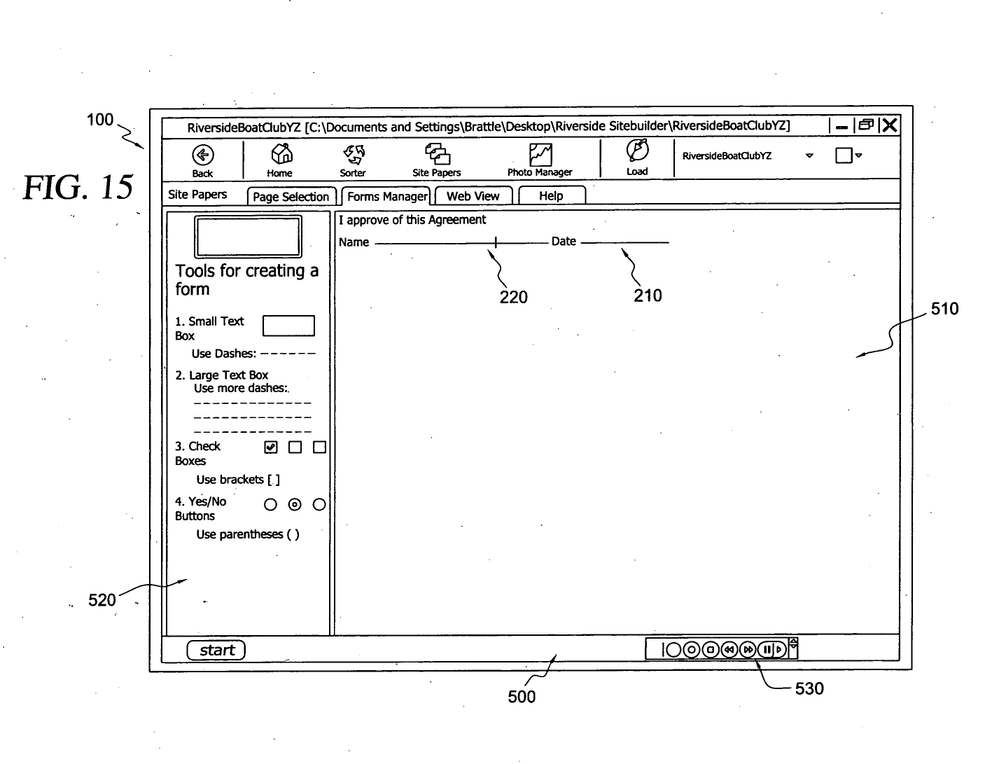

As illustrated in FIG. 15, an interface 100 provides the user with access to the Forms Manager 500. The Forms Manager 500 preferably enables the use of at least one text element 200 which may be entered into the design space 510 in order to create an input object 300. Preferably, the Forms Manager 500 includes an instruction area 520 for instructing the user in the building of the web form 400 with text elements 200. As illustrated by the example of FIG. 15, the instructions may inform the user that the text element of dashes 210, ------, may be entered in the design space 510 for creation of a small text box 310 (input object). The instructions may inform the user that a larger text box 320 may be created by entering a larger number of dashes 220. Although not shown in FIG. 15, the instructions may also inform the user that a check box 330 may be created by entering the text element of brackets 230, [ ], in the design space 510. The instructions may further inform the user that yes/no buttons 340 (input object) may created by entering the text element of parentheses 240, ( ), in the design space 510. Those of ordinary skill in the art will recognize that a variety of different text elements 200 and instructions associated therewith may be included as part of the Forms Manager 500 of FIG. 15.

FIG. 15 also illustrates use of text elements 200 for creation of the web form 400. As shown in FIG. 15, through the combination of text and text elements 210, 220 (dashes) entered within the design space 510, the user has created a representation of a web form 400 including a signature and date area for a legal or other document. Those of ordinary skill in the art will recognize that the user may enter additional text elements 200 (e.g., brackets 230, parentheses 240) within the design space 510, for the creation of additional input objects 300 as part of the web form 400. As further illustrated by FIG. 15, the user is preferably provided with a save tool 530, so that this text element 200 representation of the web form 400, which may be referred to as a “draft” form, may be saved for further editing and so on. The user may also be provided with the option of placing the “draft” form within the forms box 114 of the layout 110 previously illustrated in FIG. 14.

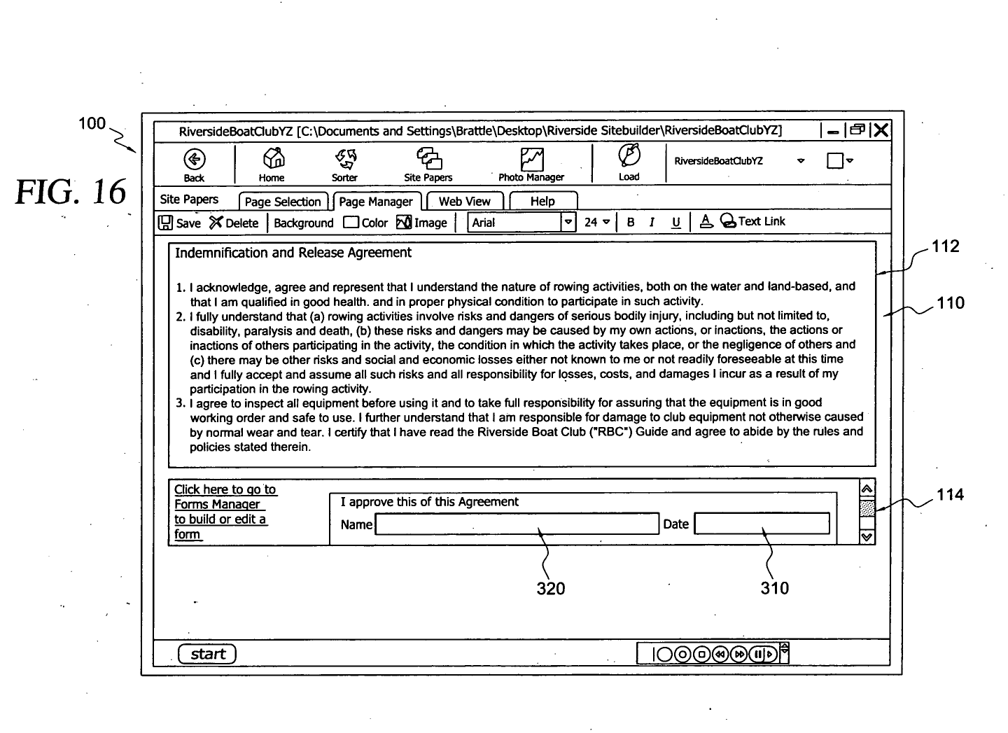

As illustrated in FIG. 16, a user interface 110 provides the user with the layout 110 including the upper, text box 112 and lower, forms box 114 as previously shown in FIG. 14. Those of ordinary skill in the art will recognize that the “draft” form of FIG. 15 has been placed within the lower, forms box 114. That is, those of ordinary skill in the art will recognize that the text elements 210, 220 shown in FIG. 15 have been translated into the input objects 310, 320 of FIG. 16. That is, the text elements 210, 220 representing signature and date text boxes have been translated into text boxes 310, 320 for entering the signature (and date) of a visitor to the web form 400. A more detailed discussion of the parser for such translation is presented below. In this example, the lower forms box 114 also includes a text link (“Click here to go to Forms Manager to build or edit a form”), allowing the user to return to the Forms Manager 500 of FIG. 15, where the user may build another form or edit the current form. Moreover, in this example, the user has included the text of a legal agreement (“Indemnification and Release Agreement”) within the upper text box 112.

Those of ordinary skill in the art will further recognize that the user interface 100, such as shown in FIG. 16, preferably also provides the user with a Web View of the created web form 400; that is, the interface preferably provides a view of the web form 400 as it will appear once published to the Internet (i.e., the web). Furthermore, preferably the user is provided with the tools and/or methods to publish the created web form 400 to the Internet, preferably within an Internet browser. In the example of FIG. 16, those of ordinary skill in the art will recognize that once the web form is published to the Internet, the text of the legal agreement will display above the signature and date input fields 310, 320.

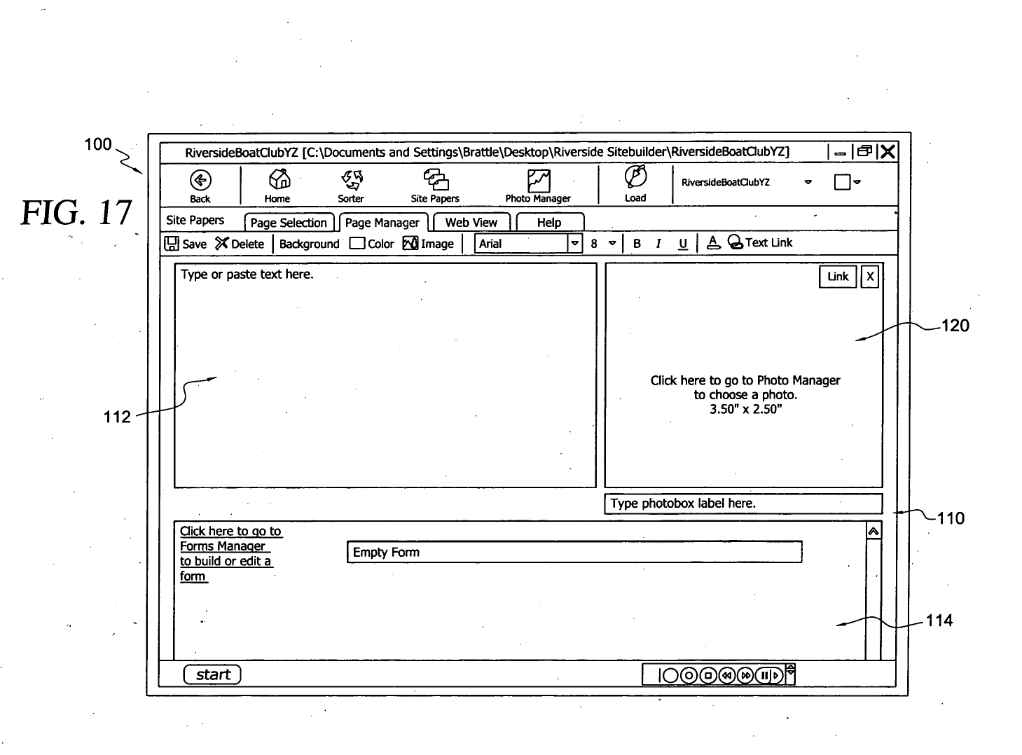

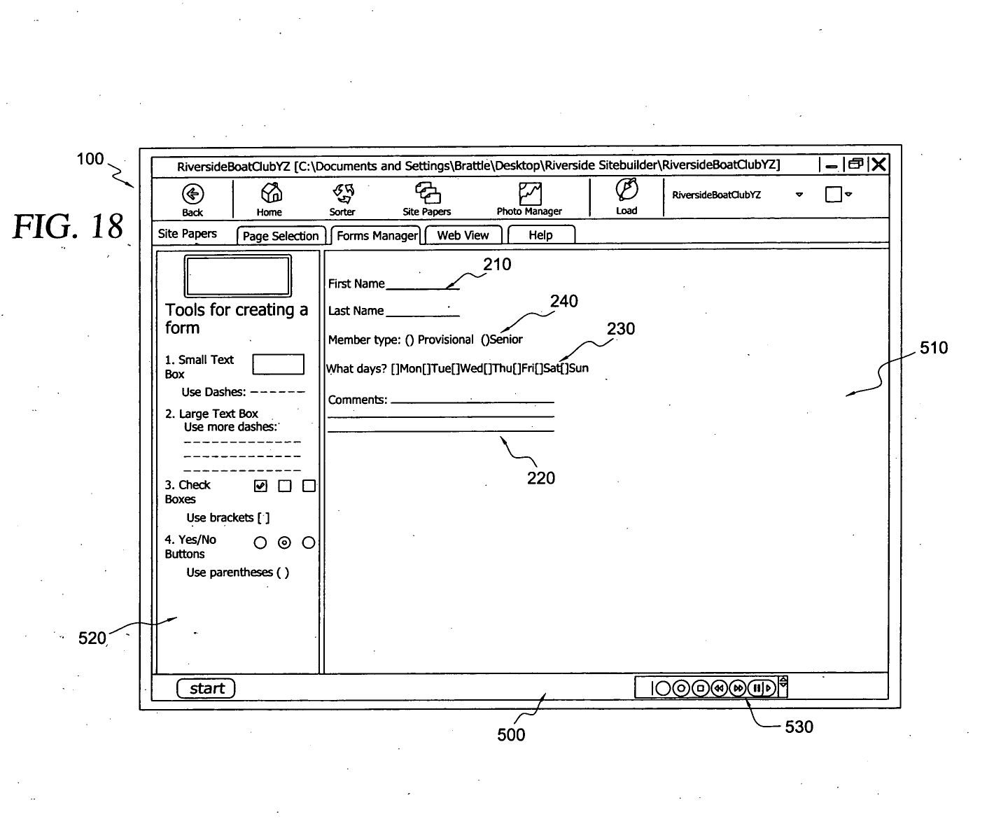

In another preferred embodiment, discussed with reference to FIGS. 17-20, the present invention encompasses a tool, method and/or computer programs through which the user may build a web form 400. As illustrated in the example of FIG. 17, via a user interface 100, the user selects a layout 110 for a web form 400 from a plurality of prescribed web form layouts 110. In another example, the user may create a custom layout 110 for the web form 400. As shown in FIG. 17, the prescribed layout 110 may include an upper left, text box 112, an upper right, photo box 120 and a lower forms box 114. The user may preferably enter text within the text box 112, insert a photo(s) (not shown) within the photo box 120, as well as begin building a web form 400 through the lower forms box 114. For instance, in this example, the lower forms box 114 allows the user to access the Forms Manager 500 via a text link (“Click here to go to Forms Manager to build or edit a form”), wherein the user may build or edit the web form 400, for instance as illustrated in FIG. 18.

As illustrated in FIG. 18, an interface 110 provides the user access to the Forms Manager 500. The Forms Manager 500 preferably enables the use of at least one text element 200 which may be entered by the user within the design space 510 in order to create an input object 300. Preferably, the Forms Manager 500 also includes an instructions area for directing the user in the use of text elements 200 for creating a web form 400. As shown in the example of FIG. 18, the instructions may inform the user that text element of dashes 210, 220 may be entered in the design space 510 for creation of a text box 310, 320. The instructions may also inform the user varying the number of dashes 210, 220 may vary the length of a text box 310, 320. The instructions may also inform the user that a check box 330 (input object) may be created by entering the text element of brackets 230 in the design space 510. The instructions may further inform the user that yes/no buttons 340 (input object) may created by entering the text element of parentheses 240 in the design space 510. Those of ordinary skill in the art will recognize that a variety of text elements 200 and instructions associated therewith may be included within the Forms Manager 500.

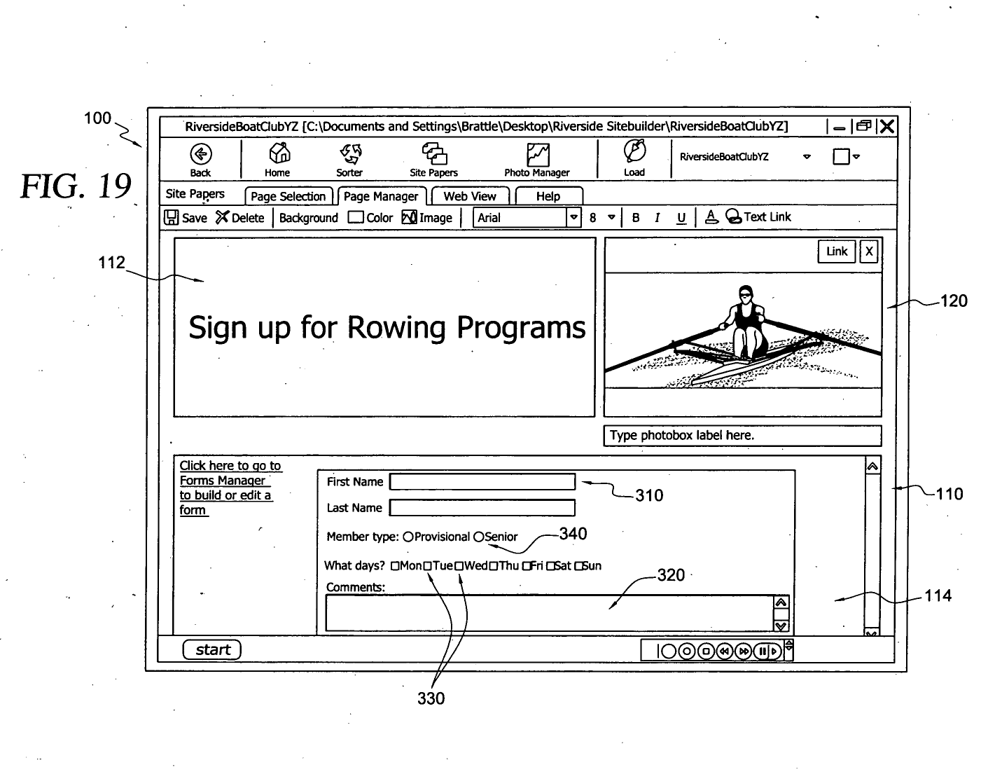

FIG. 18 further illustrates use of the text elements 200 within the design space for the building of a web form 400. As shown in FIG. 18, by entering text and the text elements of dashes, 210, 220, brackets 230 and parentheses 240 within the design space 510, the user has created a representation of a web form 400 which will eventually include the input objects of text boxes 310, 320, check boxes 330 and yes/no buttons 340, respectively. By entering text, the user may also provide labels for each of the input objects, in particular labels concerning a website visitor's First Name, Last Name, Member type, Days? and comments, as shown in both FIGS. 18 and 19. As further illustrated by FIG. 18, the user is preferably provided with a save tool 530 which allows the user the option of saving this representation of a web form, which is referred to as a “draft” form. The user is also preferably provided with the option of placing the “draft” form within the forms box 114 of the layout 110 previously illustrated in FIG. 17.

As illustrated in FIG. 19, the user interface provides the user with the layout 110 including the text box 112, forms box 114 and photo box 120 as previously shown in FIG. 17. Those of ordinary skill in the art will recognize that the “draft” form of FIG. 18 has been placed within the forms box 114. As will also be recognized by those of ordinary skill in the art, the text elements within the design space of FIG. 18 have been translated into the input objects of FIG. 19. That is, the text elements 210, 220, 230, 240 shown in FIG. 18 have been parsed into the input objects 310, 320, 330, 340 and placed within the lower forms box 114. Those of ordinary skill in the art will recognize that the parser has also attended to the spacing between the text and input objects 310, 320, 330, 340. In this example, the user has also entered text (“Sign Up for Rowing Programs”) within the text box 112 and inserted a photo within the photo box 120. Furthermore, the forms box 114 includes a text link (“Click here to go to Forms Manager to build or edit a form”), allowing the user to return to the Forms Manager 500 of FIG. 18 and build another form or edit the current form.

Furthermore, reviewing FIG. 19, those of ordinary skill in the art will recognize that the user interface 100 preferably provides the user with what is known in the art as What You See Is What You Get (“WYSWYG”). That is, the interface 100 (e.g., the Page Manger of the interface 110) preferably provides the user with a view of the page as it will appear when finished and/or published, while the page is still under construction. In other words, in accordance with preferred embodiments of the present invention, the user is preferably provided with a view of the finished and/or published page, as shown for instance in FIG. 19, without the need for additional steps such as publication which are typically required. Those of ordinary skill in the art will recognize that such WYSWYG capability greatly simplifies the process of a building a page, including a web page (e.g., a web forms 400).

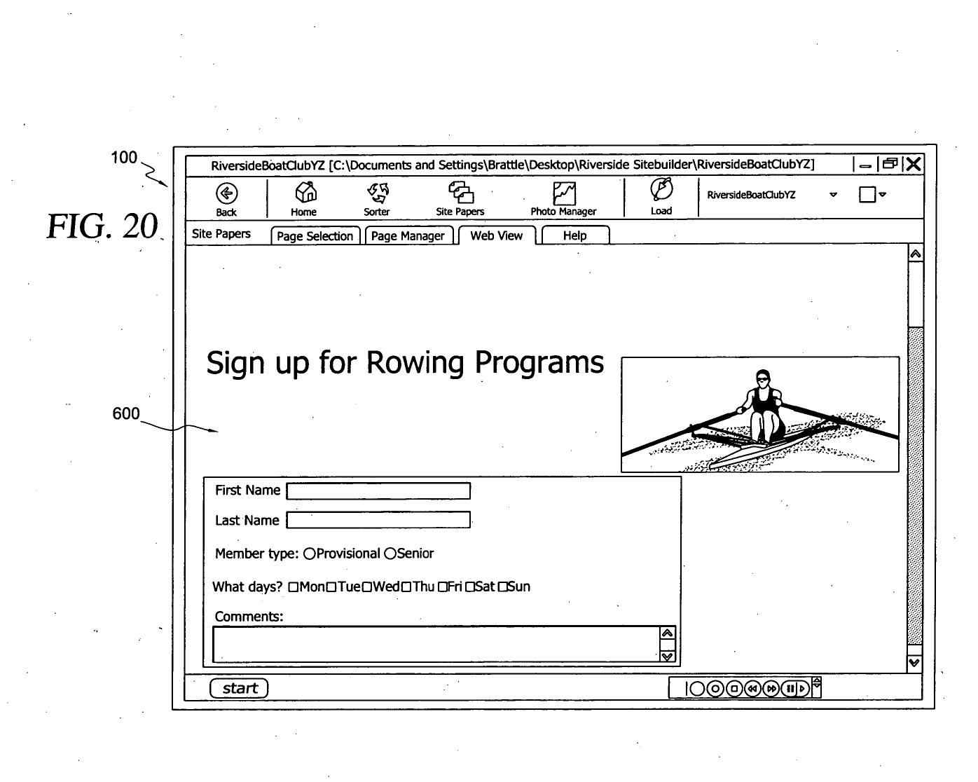

As illustrated in FIG. 20, a user interface 100 preferably provides the user with a Web View 600 of the created web form 400; that is, the interface preferably provides a view of the web form 400 as it will appear once published to the Internet (i.e., the web). The Web View preferably provides its view prior to publication of the web form 400 to the Internet. Furthermore, preferably the user is provided with the tools and/or methods to publish the created web form 400 to the Internet, preferably within an Internet browser.

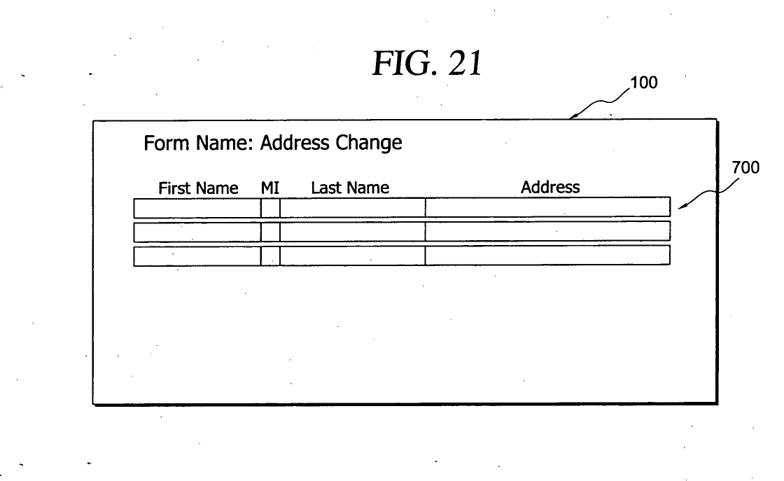

With reference to FIG. 21, those of ordinary skill in the art will recognize that in another preferred embodiment, the present invention includes a reporting tool. In one example, the reporting tool functions to create at least one report 700 which preferably displays data captured by the input object(s) 300 created by the user with text elements 200, for instance web forms 400 including such input object(s) 300 as created within the scope of the present invention. Viewed another way, the reporting tools may create reports 700 displaying the data entered into the input objects 300 by visitors to the web form 400. In the example report 700 of FIG. 21, one of ordinary skill in the art will recognize the report 700 as displaying the first name, middle initial (MI), last name and address entered into input objects 300 of a web form 400, for instance the web form 400 shown in FIGS. 10-13.

Technical Design Overview of Web Forms Creation and Reporting Tool

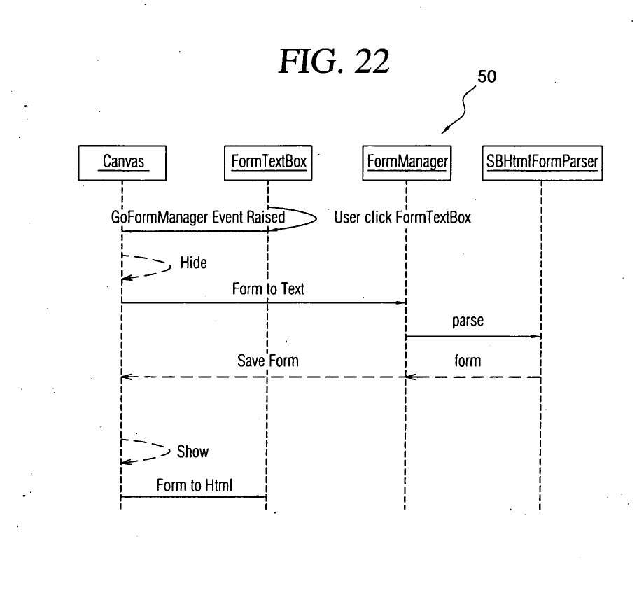

With respect to the technical design, the interface tools, methods and/or computer programs of the present invention may employ any number of preferred embodiments. For example, those of ordinary skill in the art will recognize FIG. 22 as illustrating a technical design 50 in accordance with exemplary embodiments of the present invention.

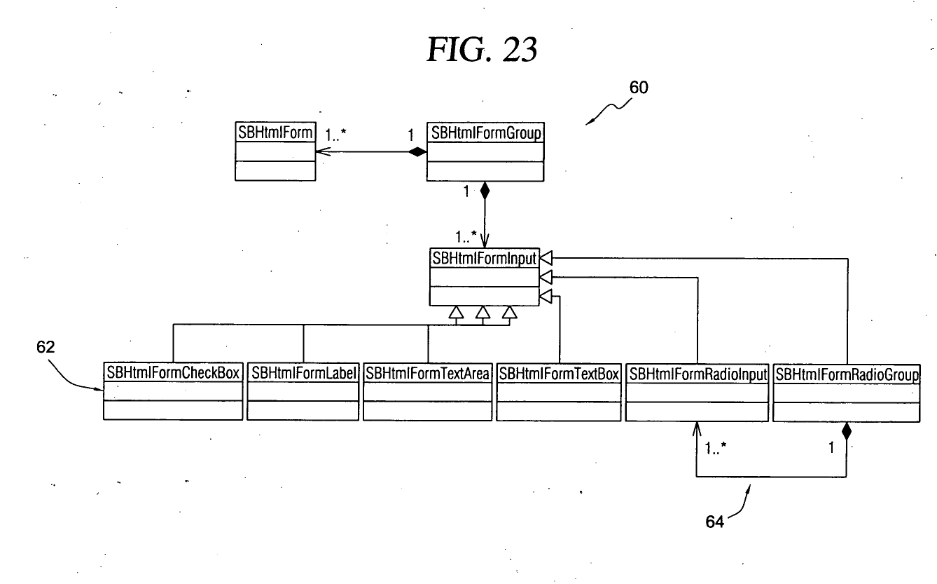

Those of ordinary skill in the art will also recognize FIG. 23 as illustrating a form group in accordance with exemplary embodiments of the present invention. Those of ordinary skill in the art will also recognize that in accordance with exemplary embodiments, the interface tools, methods and/or compute programs of the present invention include a form library 60 that encapsulates at least one web (e.g., HTML) form 400 and its layout 110. The form library 60 preferably provides the web form(s) 400 and layout(s) 110 selected by the user when building a web form 400 in accordance with the preferred embodiments of the present invention. With reference to FIG. 23, those of ordinary skill in the art will recognize that the form inputs 62 in the same form are grouped horizontally. Similarly, a radio group 64 represents radio inputs aligned horizontally. Those of ordinary skill in the art will recognize, however, that the form library 60 and groups may occur in a variety of configurations.

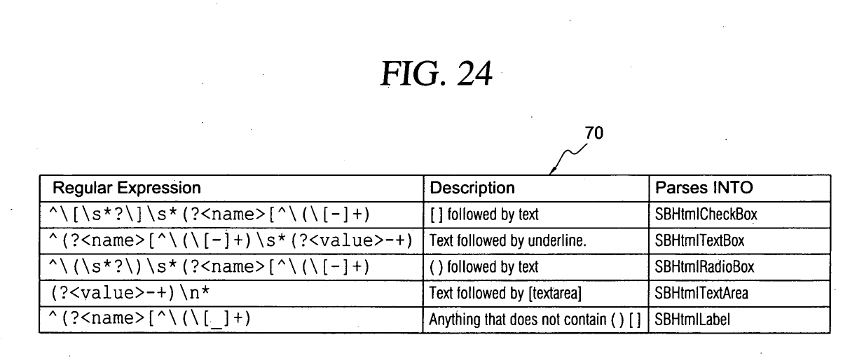

In accordance with preferred embodiments, the interface tools, methods and/or computer programs of the present invention include a parsing tool or parser. As discussed above, the parsing tool is a tool that translates a text element 200 into an input object 300. The parsing tool is preferably a software application, more preferably computer instructions. Preferably, the parsing tool translates text elements 200 into classes within the form library 60. In one example, the parsing tool utilizes a set of regular expressions to parse the text element 200. The table 70 of FIG. 24 illustrates such regular expressions in accordance with the exemplary embodiments of the present invention, as will be recognized by those of ordinary skill in the art. Those of ordinary skill in the art will also recognize that for each text line, the method parseLine is called, for example:

private void parseLine(int groupId, string line, SBHtmlForm form)
{

SBHtmlFormGroup group = new SBHtmlFormGroup(form, groupId);
SBHtmlFormRadioGroup radioGroup = null;
SBHtmlFormGroup prevGroup = form.GetAt(form.Count);
string label;
Match m, ml;
int index, id = l;
int groupLevel = l;
while (line.Length > 0)
{

line = line.TrimEnd(‘ ’);
line = line.TrimEnd(‘\n’);
line = line.TrimEnd(‘\r’);
// check for textbox
#region TextBox RegEx

m = _textboxRegEx.Match(line);
if (m.Success)
{

SBHtmlFormTextBox textBox = handleTextBoxEntry(id++, m);
group.addFormInput(textBox);
index = m.Index + m.Length;
line = line.Substring(index, line.Length − index);
continue;

}
#endregion
#region CheckBox RegEx
m = _checkboxRegEx.Match(line);
if (m.Success)
{

label = m.Groups[“name”].Value;
label = Regex.Replace(label, @“\s”, “”);
if (label.Length > 0)
{

SBHtmlFormCheckBox checkBox = handleCheckboxEntry(id++,

m);

group.addFormInput(checkBox);
index = m.Index + m.Length;
line = line.Substring(index, line.Length − index);
continue;

}

}
#endregion
#region RadioButton RegEx
m = radioRegEx.Match(line);
if (m.Success)
{

label = m.Groups[“name”].Value;
label = Regex. Replace(label, @“\s”, “”);
if (label.Length > 0)
{

if (radioGroup == null)
{

// check if there exists a previous radio group
if (prevGroup != null)
{

SBHtmlFormInput input =

prevGroup.GetAt(prevGroup.Count);

if ((input != null) && (input.InputType ==

FormInput.RadioGroup))

{

radioGroup = (SBHtmlFormRadioGroup) input;
groupLevel = radioGroup.Levels + 1;

}
else
{

radioGroup = new SBHtmlFormRadioGroup(id++,

“”);

group.addFormInput(radioGroup);

}

}
else
{

radioGroup = new SBHtmlFormRadioGroup(id++, “”);
group.addFormInput(radioGroup);
}

}
SBHtmlFormRadioInput radioInput =

handleRadioInputEntry(radioGroup.Count + 1, radioGroup.Id, groupLevel, m);

radioGroup.addRadioInput(radioInput);
index = m.Index + m.Length;
line = line.Substring(index, line.Length − index);
continue;

}

}
#endregion
#region TextArea RegEx
m = _textareaRegEx.Match(line);
if (m.Success)
{

label = line.Substring(m.Length, line.Length − m.Length);
m1 = Regex.Match(label, @“[\hat{ }-\f\n\r\t\v)”,

RegexOptions.None);

if (!m1.Success)
{

SBHtmlFormTextArea txtAreaBox =

handleTextAreaEntry(id++, m, line);

group.addFormInput(txtAreaBox);
if (prevGroup.Count == 1)
{

SBHtmlFormInput lastInput = prevGroup.Last ( );
if (lastInput is SBHtmlFormTextBox)
{

form.RemoveAt(form.Count);
txtAreaBox.Text = lastInput.Text;
txtAreaBox.Row = txtAreaBox.Row + 1;

}
else if (prevGroup.onlyText)
{

form.RemoveAt(form.Count);
txtAreaBox.Text = prevGroup.GetAt(1).Text;

}

}
line = “”;
break;

}

}
#endregion
#region Label RegEx
m = _labelRegEx.Match(line);
if (m.Success)
{

SBHtmlFormLabel text;
if ((group.Count > 0) && (group.GetAt(1).InputType ==

FormInput.Label))

{

text = (SBHtmlFormLabel)group.GetAt(1);
text.Text = text.Text + ‘ ’ + getMatchName(m);

}
else
{

text = handleLabelEntry(id++, m);
group.addFormInput(text);

}
index = m.Index + m.Length;
line = line.Substring(index, line.Length − index);
continue;

}
#endregion
break;

}
if (line.Length > 0)
{

SBHtmlFormLabel text2;
if ((group.Count > 0) && (group.GetAt(1).InputType ==

FormInput.Label))

{

text2 = (SBHtmlFormLabel)group.GetAt(1);
text2.Text = text2.Text + ‘ ’ + line;

}
else
{

text2 = handleLabelEntry(id++, line); ;
group.addFormInput(text2);

}

}
// check for text collapse
if ((prevGroup != null) && (group.onlyText && prevGroup.onlyText))
{

SBHtmlFormlabel txt = (SBHtmlFormLabel)prevGroup.GetAt(1);
SBHtmlFormLabel myGroup = (SBHtmlFormLabel)group.GetAt(1);
txt.Text = txt.Text + @“\n” + myGroup.Text;

}
else
{

if ((prevGroup != null) && (group.Type != prevGroup.Type))

group.Section = prevGroup.Section + 1;

form.addFormGroup(group);

}

}

Photo Sizing, Composing and Cropping Tool

The present invention relates to systems, methods, and/or computer software applications for the management of photos and other images, in particular digital photos and images. The systems, methods and/or applications of the present invention preferably provide the user with at least one interface 100 through which a layout 110 (or design) of a page for displaying photos (e.g., web page) may be selected or created by the user. The systems, methods and/or applications of the present invention preferably allow the user to provide for at least one photo within the layout 110. The systems, methods and/or applications of the present invention preferably allow a user to manage photos and other images via a photo manager 2000 comprising photo management tools. Preferably, the photo manager 2000 comprises an image editor 2100 having integrated photo composing, resizing and cropping functionality. Preferably, the photo manager 2000 comprises an image editor 2100, photo resize tool 2200 and/or photo cropping tool 2300. Preferably, the image editor 2100 comprises a photo resize tool 2200 and/or a photo cropping tool 2300. As discussed in detail below, those of ordinary skill in the art will recognize that through the use of the present invention, preferably the photo manager 2000 and/or image editor 2100, the user is provided with improved and simplified techniques for the management of photos and other images.

Those of ordinary skill in the art will recognize that the present invention generally relates to improved systems, methods and/or computer applications for the management of photos and other images, in particular digital photos on a web page or website. Through the present invention, the user with limited knowledge of computer software, web design or even the photographic arts may effectively manage their photos, including the loading, modifying and/or displaying their photos, within an online or offline environment.

In one example, the present invention relates to methods of managing photos. The methods of the present invention preferably include providing a user interface 100 comprising a photo manager 2000. The photo manager 2000 preferably comprises an image editor 2100, wherein the image editor 2100 has a defined boundary 3100. The methods preferably include superimposing the image editor 2100 over at least a section of a photo. The methods also preferably include resizing at least a portion of the photo within the defined boundary 3100 of the image editor 2100. Preferably, the methods include moving the image editor 2100 over the photo so that a desired section of the photo rests within the defined boundary 3100 of the image editor. Preferably, the methods include cropping the photo as defined by the boundary 3100 of the image editor 2100.

In another example, the present invention relates to photo management systems. The systems of the present invention preferably include a photo manager 2000 comprising an image editor 2100. The systems of the present invention preferably include a photo manager 2000 comprising a photo resize tool 2200. The image editor 2100 preferably has a defined boundary 3100. The image editor 2100 is preferably superimposable over a photo. The systems of the present invention preferably include a photo resize tool 2200 providing for resizing at least a section of the photo within the defined boundary 3100 of the image editor 2100. Preferably, the systems of the present invention include the image editor 2100 being movable over the photo so that a desired section of the photo rests within the defined boundary 3100 of the image editor 2100. Preferably, the systems include a cropping tool 2300 for cropping the photo as defined by the boundary 3100 of the image editor 2100.

In another example, the present invention relates to computer readable storage medium on which is embedded one or more computer programs. Preferably, the one or more computer programs implement a method for managing photos. More preferably, the one or more computer programs include a set of instructions for providing a user interface 100 comprising a photo manager 2000. The photo manager preferably includes an image editor 2100, wherein the image editor 2100 has a defined boundary 3100. Preferably, the one or more computer programs include a set of instructions for superimposing the image editor 2100 over at least a portion of a photo. Preferably, the one or more computer programs include a set of instructions for resizing at least a section of the photo within the defined boundary 3100 of the image editor 2100. Preferably, the one or more computer programs include a set of instructions for moving the image editor 2100 over the photo so that a desired section of the photo rests within the defined boundary 3100 of the image editor 2100. Preferably, the one or more computer programs include a set of instructions for cropping the photo as defined by the boundary 3100 of the image editor 2100.

In another example, the present invention relates to methods of managing photos, wherein said methods include providing a user interface 100 comprising a layout 110, wherein said layout 110 comprises at least one photo box 120 for the placement of at least one photo; accessing a photo manager 2000 via said photo box 120; and providing the photo manager 2000 within a user interface 100. Preferably, the methods include the photo manager 2000 comprising an image editor 2100, the image editor 2100 having a defined boundary 3100; superimposing the image editor 2100 over at least a portion of a photo; and resizing at least a section of the photo within the defined boundary 3100 of the image editor 2100. Preferably, the methods include moving the image editor 2100 over the photo so that a desired section of the photo rests within the defined boundary 3100 of the image editor 2100.

In another example, the present invention relates to photo management systems, wherein the systems include a first user interface 100 for providing the user with a layout 110, wherein said layout 110 comprises at least one photo box for the placement of at least one photo; and a second user interface 110 for providing the user with a photo manager 2000, wherein said photo manager 2000 is accessible via said photo box 120. Preferably, the systems include the photo manager 2000 comprising an image editor 2100; the image editor 2100 having a defined boundary 3100 and superimposable over a photo; and a resize tool 2200 providing for resizing at least a section of the photo within the defined boundary 3100 of the image editor 2100. Preferably, the systems include the image editor 2100 movable over the photo so that a desired section of the photo rests within the defined boundary 3100 of the image editor 2100. Preferably, the systems include a cropping tool 2300 for cropping the photo as defined by the boundary 3100 of the image editor 2100.

In view of the examples described herein, those of ordinary skill in the art will recognize that the present invention preferably includes a photo manager 2000. The photo manager 2000 preferably includes tools for composing, resizing and/or cropping photos. The photo manager 2000 preferably includes the image editor 2100. The photo manger 2000 preferably includes the photo resize tool 2200 or photo cropping tool 2300. In one example, the photo manager 2000 is accessed by a photo box 120 provided in a layout 110. The photo manager 2000 is preferably provided in a user interface 100, through which a user interacts with the photo manger 2000. Those of ordinary skill in the art will recognize that the photo manager 2000 allows for the management of photos including, but not limited to, composing, sizing or resizing, cropping and/or displaying photos. It will be appreciated that the photo manager 2000 may greatly enhances a user's capabilities to manager and display photos, whether online or offline.

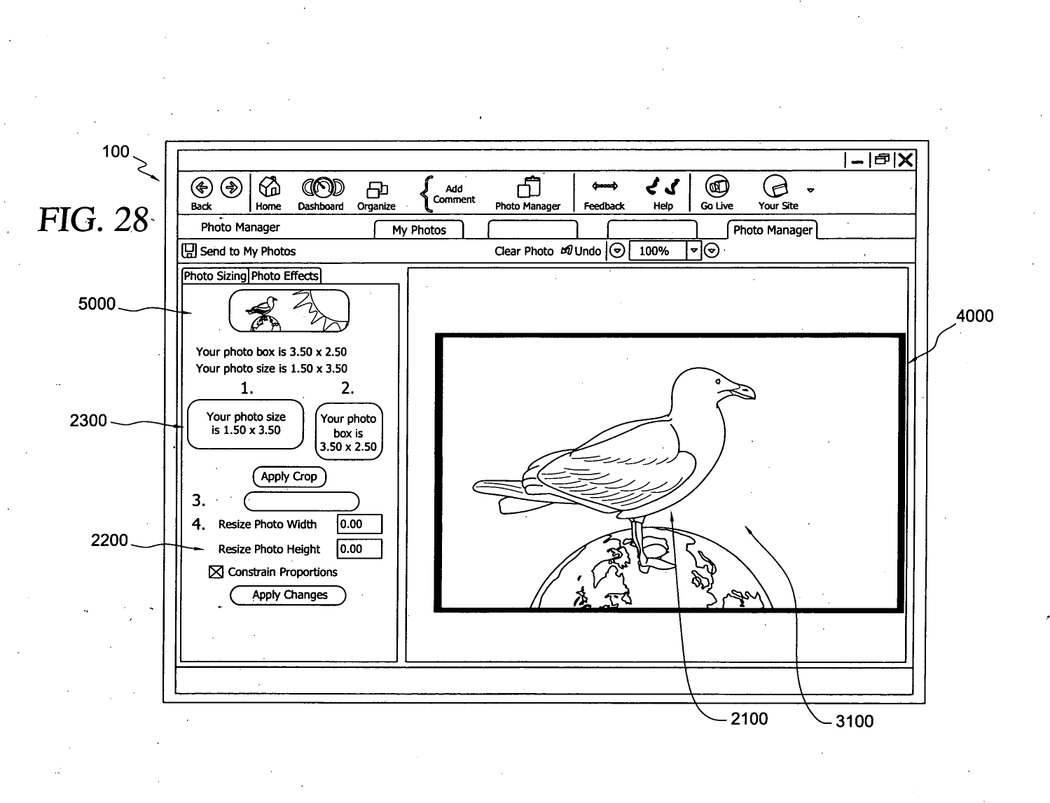

Those of ordinary skill in the art will recognize that the present invention preferably includes an image editor 2100. Preferably, the image editor 2100 has a defined boundary 3100. For example, as illustrated in FIG. 28, the image editor 2100 is provided as a square box, wherein the outer edges of the box form the defined boundary 3100. In another example, the image editor 2100 may be provided as a circle, wherein the outer circumference of the circle forms the defined boundary 3100. In other words, those of ordinary skill in the art will recognize that the image editor 2100 and its defined boundary 3100 may be provided as a variety of configurations, whether a square, rectangle, circle, triangle or other. Those of ordinary skill in the art will recognize that the area within the defined boundary 3100 preferably forms a preferred working area for a photo, wherein the photo may be composed, sized or resized, cropped or worked with a tool for photo management. In one example, the size and/or shape of the defined boundary 3100 is determined by the size of the photo box 120 through which the photo manager 2000 is accessed. Yet, preferably the size (and/or shape) of the defined boundary 3100 may be modified or changed by the user. In another example, rather than the size and/or shape of the defined boundary 3100 being determined by a photo box 120, the present invention allows the user to determine the size and/or shape of the defined boundary 3100, for instance through the use of controls within the photo manager 2000.

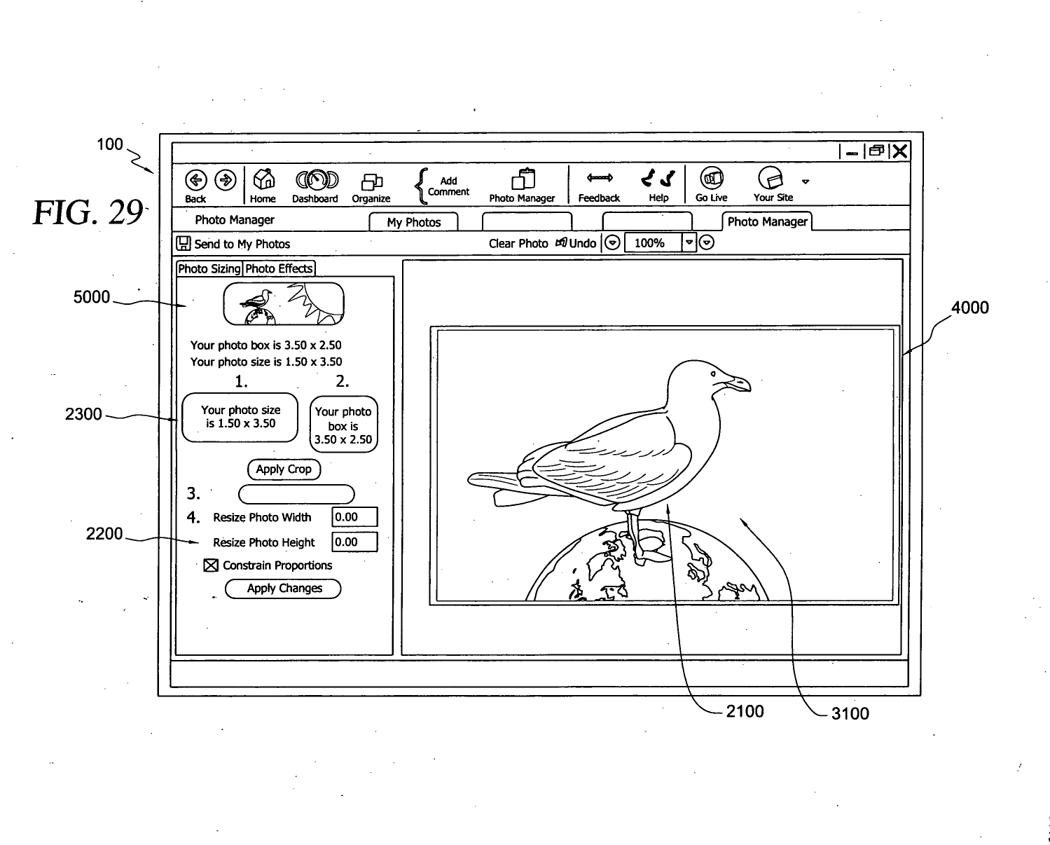

Preferably, the image editor 2100 may be superimposed over a photo. That is, the image editor 2100 is preferably superimposable, more preferably superimposable on a photo. For example, as illustrated in at least FIGS. 28 and 29, the image editor 2100 is superimposed over a photo. A section of the photo rests or remains within the defined boundary 3100 of the image editor 2100, so as to provide a preferred section of the photo to be managed. However, it should be recognized that the section(s) of the photo that remain outside the defined boundary 3100 may also be managed. Preferably such section(s) may be resized, but more preferably the sections of the photo within and without the defined boundary 3100 may be resized. In fact, in accordance with the preferred embodiments of the present invention, the photo manager 2000 allows the user to manager the entire photo, while preferably managing the section of photo that rests or remains within the defined boundary 3100 of the image editor 2100. In one example, the entire photo may be resized so that the entire photo fits within the defined boundary 3100 of the image editor 2100. In another example, the photo may be resized so that the section of the photo already within the defined boundary 3100 is provided with a desired arrangement or fit within the defined boundary 3100.

Preferably, the image editor 2100 is movable over a photo. More preferably, the image editor 2100 may be moved over a photo so that any section of the photo may rest or remain within the defined boundary 3100 of the image editor 2100. For example, as illustrated in FIGS. 28 and 29, the image editor 2100 may be moved over the photo so as to fit as much as possible of an image (e.g., the seagull) within the defined boundary 3100 of the image editor 2100. In another example, however, the image editor 2100 may be moved so that any desired section of a photo rests within the defined boundary 3100 of the image editor 2100. In other words, in that the image editor 2100 is movable, those of ordinary skill in the art will recognize that the image editor 2100 may be superimposed over any section of the photo a user desires.

In view of the examples described herein, those of ordinary skill in the art will recognize that the present invention preferably includes a photo resize tool 2200. Preferably, a photo resize tool 2200 may be included as part of the photo manager 2000. A photo resize tool 2200 and its function, in accordance with the preferred embodiments of the present invention, may be described below, with reference to the drawings. Those of ordinary skill in the art will recognize that the photo resize tool 2200 preferably also includes controls for its operation by a user, as also described below.

In view of the examples described herein, those of ordinary skill in the art will also recognize that the present invention preferably includes a photo cropping tool 2300. Preferably, a photo crop tool 2300 may be included as part of the photo manager 2000. A photo crop tool 2300 and its function, in accordance with the preferred embodiments of the present invention, may be described below, with reference to the drawings. Those of ordinary skill in the art will recognize that the photo crop tool 2300 preferably also includes controls for its operation by a user, as also described below.

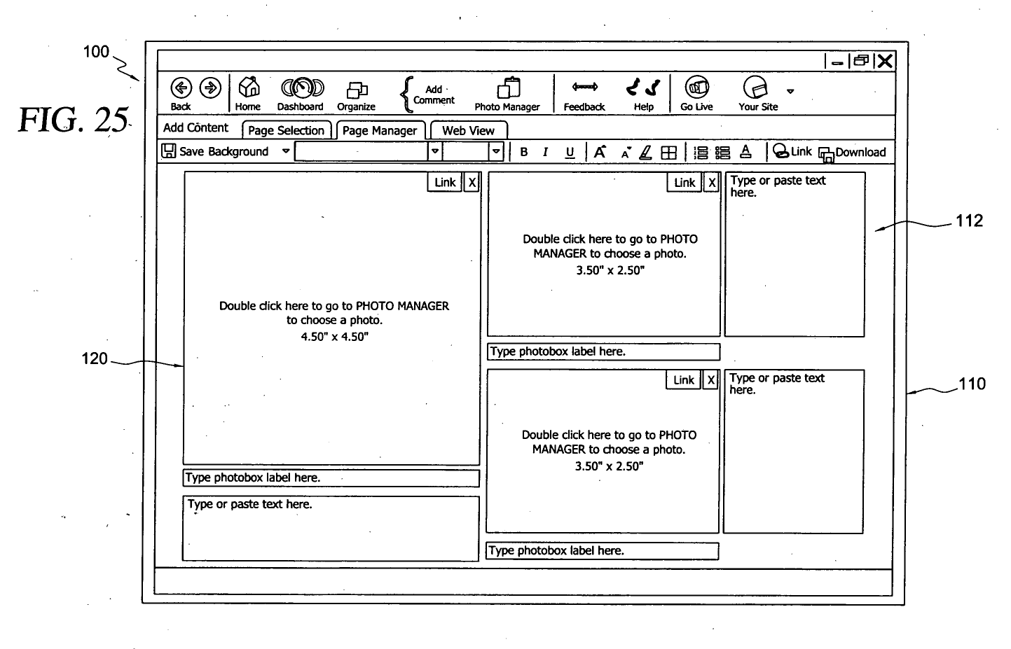

In one example of the preferred embodiments of the present invention, an interface 100 provides the user with at least one layout 110, wherein the layout 110 includes at least one (or a plurality) photo box 120, for instance as illustrated by FIG. 25. However, those of ordinary skill in the art will recognize that the user may also be preferably provided with the capability of creating a “custom” layout 110. That is, in accordance with preferred embodiments of the present invention, the user may be provided with an empty layout 110 along with the means for locating desired content areas, particularly photo boxes 120, within the layout 110 wherever the user so chooses. Those of ordinary skill in the art will recognize that the user may be provided with a variety of means for customizing a layout 110, such as a control tool located within a tool bar. Those of ordinary skill in the art will also recognize that a control tool may be in the form of various preferred embodiments, for instance a drawing tool or a select-and-drag tool which allows the user with the option of drawing or selecting-and-dragging a photo box 120 within a layout 110 in a “custom” configuration.

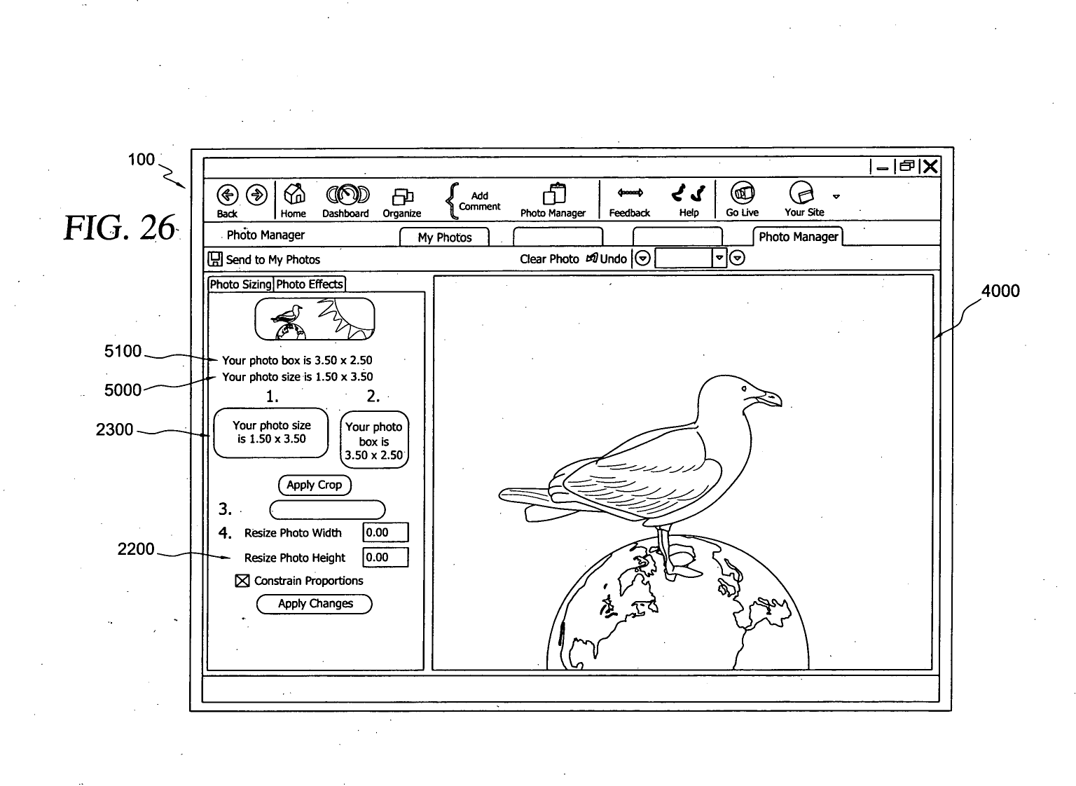

As illustrated in FIGS. 25 and 26, the photo manager 200 is preferably accessed via the photo box 120. Preferably, the user accesses the photo manager 200 by clicking (e.g., with a computer mouse) on a photo box 120. Preferably, through the photo box 120, the user may load a photo or image within the photo manager 200 for photo management. Preferably, the user places a photo or image within the photo manager 200 by clicking (e.g., with a computer mouse) on the photo box 120. Those of ordinary skill in the art will recognize that the photo may be preferably stored in a photo library, for example a computer hard drive or other electronic medium, wherein clicking on a photo box 120 provides the user with the option of selecting a desired stored photo from the photo library and loading the selected photo into the photo manager 200.

In another example, an interface 100 provides the user with a photo manager 200 which includes photo management capabilities. For example, the photo manager 200 may include an image editor 210, photo resize tool 220, photo crop tool 230 and/or other tools for the management of photos and other images. Those of ordinary skill in the art will recognize that such photo management tools need not be separate and independent tools, but rather may be integrated. That is, any combination or even all photo management tools may be included as part of a single element (e.g., tool) of the present invention, for instance a single element (e.g., tool) included within the photo manager 200. In one example, as illustrated in at least FIGS. 28-30, the photo manager 200 preferably includes an image editor 210 which may be superimposed over a photo loaded into the photo manager 200. Preferably, the user moves the image editor 210 over the photo so that the desired section of the photo remains within the defined boundary 310 of the image editor 210. Those of ordinary skill in the art will recognize that a number of tools for moving the image editor 210 may be provided, for instance a computer mouse. Preferably, the photo may be resized so as to better fit within the image editor 210. Furthermore, the photo may be preferably cropped as defined by the boundary 310 of the image editor 210. That is, the photo may be cropped so that only the section within the defined boundary 310 remains (and thereafter may be placed within the photo box 120 of the layout 110).

Those of ordinary skill in the art will recognize that the preferred embodiments of the present invention, as discussed herein with reference to figures and examples, encompass systems methods and/or computer programs through which a user manages photos and other images. Those of ordinary skill in the art will recognize that the photo management capabilities of the present invention preferably include, but are not limited to, the selecting, composing, sizing or resizing, cropping and/or displaying of photos and images.

As illustrated in FIG. 25, an interface 100 provides the user with a layout 110 for the display of photos and other images. In one example, an interface 100 may allow the user to create a desired layout 110. In another embodiment, the interface 100 may include at least one prescribed layout, wherein the user selects a layout 110 from those provided. As shown in FIG. 25, the layout may include at least one photo box 120, preferably a plurality of photo boxes of varying size. The layout may also include at least one text box 112 or boxes in which the user may enter (e.g., type of paste) and display text. Preferably, a photo manager 200 is accessed via a photo box 120, preferably by clicking (e.g., with a computer mouse) on the photo box. For instance, clicking on a photo box 120 may provide the user with the option of selecting a desired stored photo from the photo library and loading the selected photo into the photo manager 200. Those or ordinary skill in the art will recognize that the layout 110 preferably provides the user with a layout 110 for the display of photos and/or other images, preferably the display of photos on a page, more preferably a web page.

As illustrated in at least FIG. 26-31, an interface 100 provides access to the photo manager 200, which is preferably accessed via a photo box 120 as shown in FIG. 25. In one example, as shown in FIG. 26, the photo manager 200 comprises a main photo area 400 for display of a photo or image and a tool area 500 comprising photo management tools and/or controls for photo management tools. Preferably, a photo is loaded and displayed within the main photo area 400 from a photo library or a photo storage medium. Those of ordinary skill in the art will recognize that the photo library or photo storage medium may take a variety of forms including, but not limited to, a hard drive located on a computer or elsewhere. In a preferred embodiment, as shown in FIG. 26, the tool area 500 includes controls 1, 2, 3, 4 for the image editor 210, resize tool 220 and crop tool 230 of the photo manager 200. In another preferred embodiment, as shown in FIG. 26, the photo manager 200 displays the size (3.50″×2.50″) 510 of the photo box 120 through which the photo manager 200 is accessed. However, it will be recognized that in preferred embodiments of the present invention, the user is provided with the option of changing the size of the photo box 120.

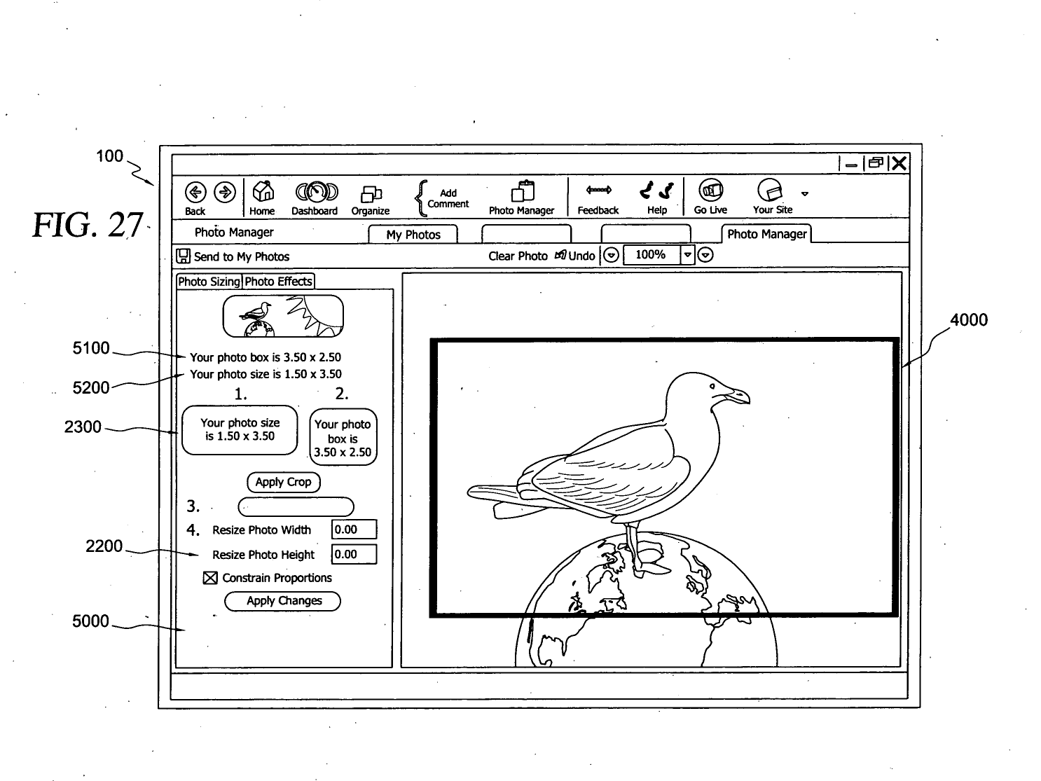

As illustrated in FIG. 27, an interface 100 provides access to the photo manager 200, wherein a photo has been loaded and displayed within the main photo area 400. In one preferred embodiment, when the photo is displayed in the main photo area 400, the tool area 500 displays both the size (3.50″×2.50″) 510 of the photo box 120 and the actual size of the photo (10.00″×6.00″) 520. Those of ordinary skill in the art will recognize that displaying the actual size of the photo and the photo box 120 will aid the user in composing, sizing or resizing, cropping and/or displaying the photo, that is, in managing the photo.

As illustrated in FIG. 28, an interface 100 provides access to the photo manager 200, wherein the image editor 210 has been superimposed over the photo. Those of ordinary skill in the art will recognize that a variety of techniques may be employed to launch and superimpose the image editor 210. In one preferred embodiment, the image editor 210 may be launched through the use of the controls 1, 2, 3, 4 located within the tool area 500 of the photo manager 200. For example, as shown in FIG. 28, the user may click on control 1, thereby launching and superimposing the image editor 210 on the photo displayed in the main photo area 400. In this example, and preferably, the defined boundary 310 of the image editor 210 is the same size as the size (3.50″×2.50″) of the photo box 120 through which the photo manager 200 is accessed. Those of ordinary skill in the art will recognize that because the defined boundary 310 of the image editor 210 is preferably launched having the same size as the photo box 120, the user is provided with the opportunity to manage a photo of the same size as will eventually be displayed within photo box 120 of the layout 110. Furthermore, because the image editor 210 may be preferably moved, so that the defined boundary 310 of the image editor 210 encompasses a different section(s) of the photo, the user may select the section(s) of photo that appear within the photo box 120 of the layout 110.

As illustrated in FIG. 29, an interface 100 provides access to the photo manager 200, including the superimposable and movable image editor 210. As discussed above, the image editor 210 is preferably movable, so that the defined boundary 310 of the image editor 210 encompasses almost any desired section of the photo displayed within the main photo area 400. Those of ordinary skill in the art will recognize that a number of tools for moving the image editor 210 may be provided for the user, for instance a computer mouse, a computer keyboard and so on. In this example, as shown in FIG. 29, the image editor 210 has been moved in an attempt to fit the seagull's head, as large as possible, within the defined boundary 310 of the image editor 210.

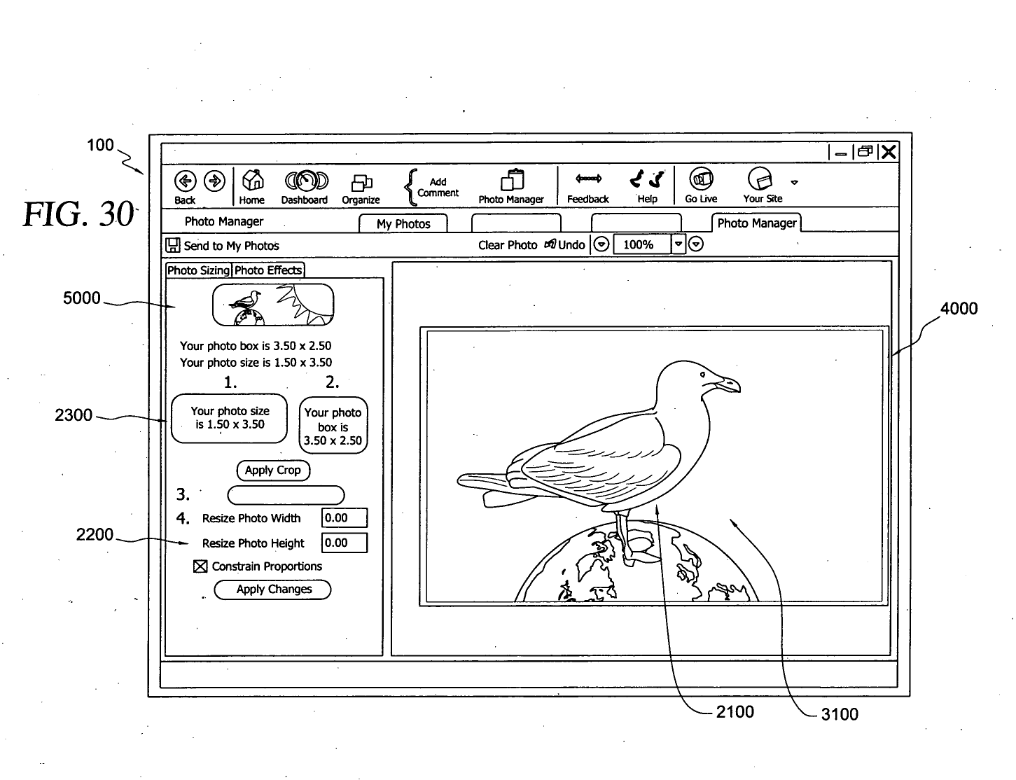

As illustrated by FIG. 30, an interface 100 provides access to the photo manager 200, including the photo crop tool 230. Those of ordinary skill in the art will recognize that, in accordance with the preferred embodiments of the present invention, whether before or after resize of the photo, the photo crop tool 230 may be used to crop the photo as defined by the boundary 310 of the image editor 210. In other words, the photo may be cropped so that only the section within the defined boundary 310 remains. In this example, the photo crop tool 230 is controlled via the tools located in the tool area 500; that is, the user clicks on the control labeled “Apply Crop”. As a result, the photo is cropped so that only the section of the photo within the defined by the boundary 310 of the image editor 210 is displayed within the photo manager 200. In sum, the user has composed the photo to include the seagull's head and cropped the photo to the same size (3.50″×2.50″) as the photo box 120. Preferably, the photo manager 200 also allows the user to save and place the composed and cropped (and possible resized) photo within the photo box 120 of the layout. That is, as further shown in FIG. 30, the user is preferably provided with a save tool 600, so that the photo is saved and/or placed within the photo box 120 of the layout 110. In this example, the user preferably selects the save tool (“Save and Place in Photo Box”) 600 and, as a result, the cropped photo is placed within the photo box 120 of the layout 110.

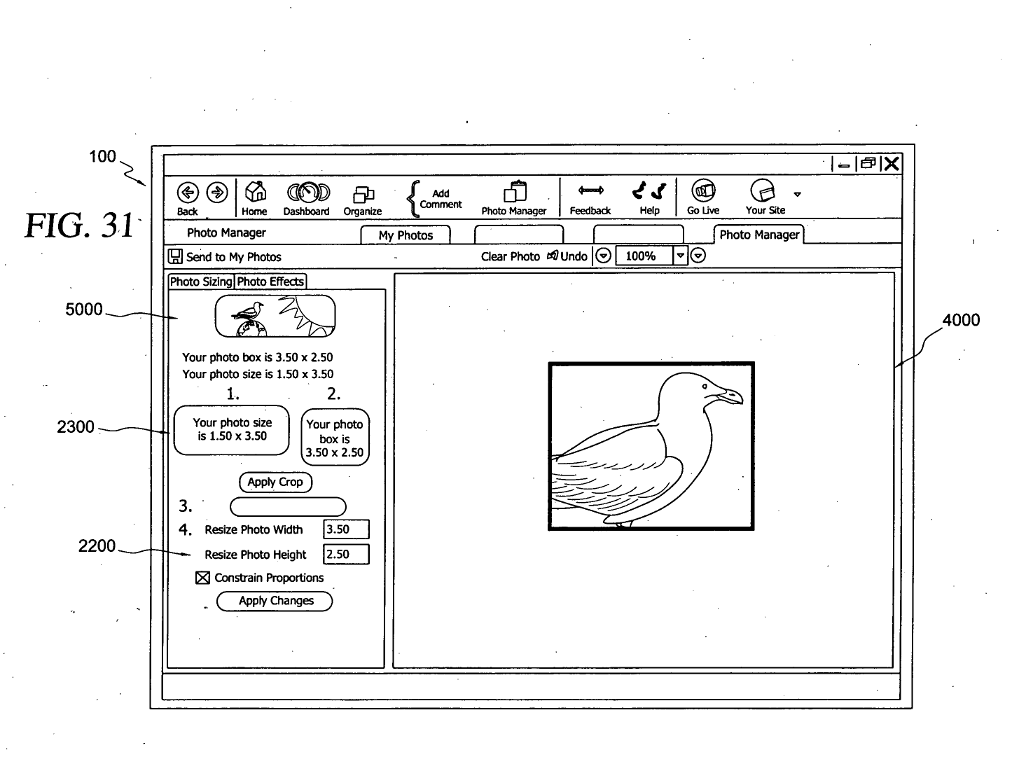

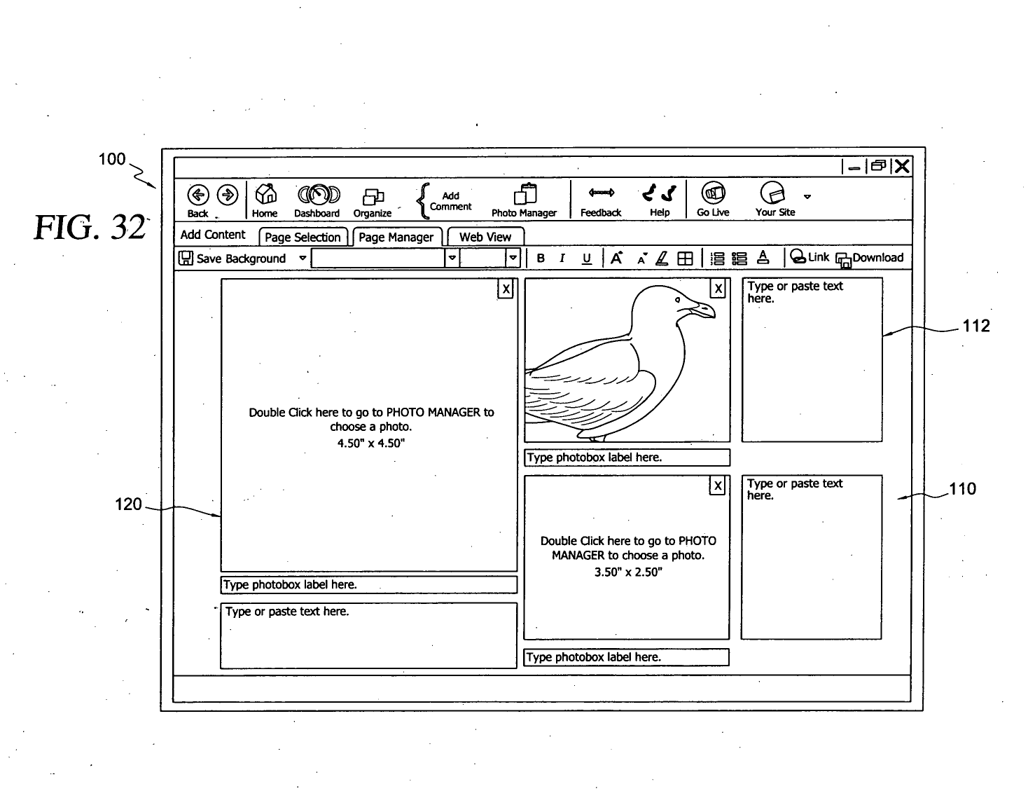

As illustrated by FIG. 31, an interface 100 provides access to the photo manager 200, wherein the cropped photo of FIG. 30 is displayed in the main photo area 400. In this example, after selecting the save tool (“Save and Place in Photo Box”) 600 as illustrated in FIG. 30, the photo was placed within the photo box 120 of the layout 110. With reference to both FIG. 30 and FIG. 31, those of ordinary skill in the art will recognize that the photo has been cropped to the size and section defined by the boundary 310 of the image editor 210. As a result, the photo has been sized to fit precisely within the photo box 120 of the layout 110 of FIG. 25 (now shown in FIG. 32).

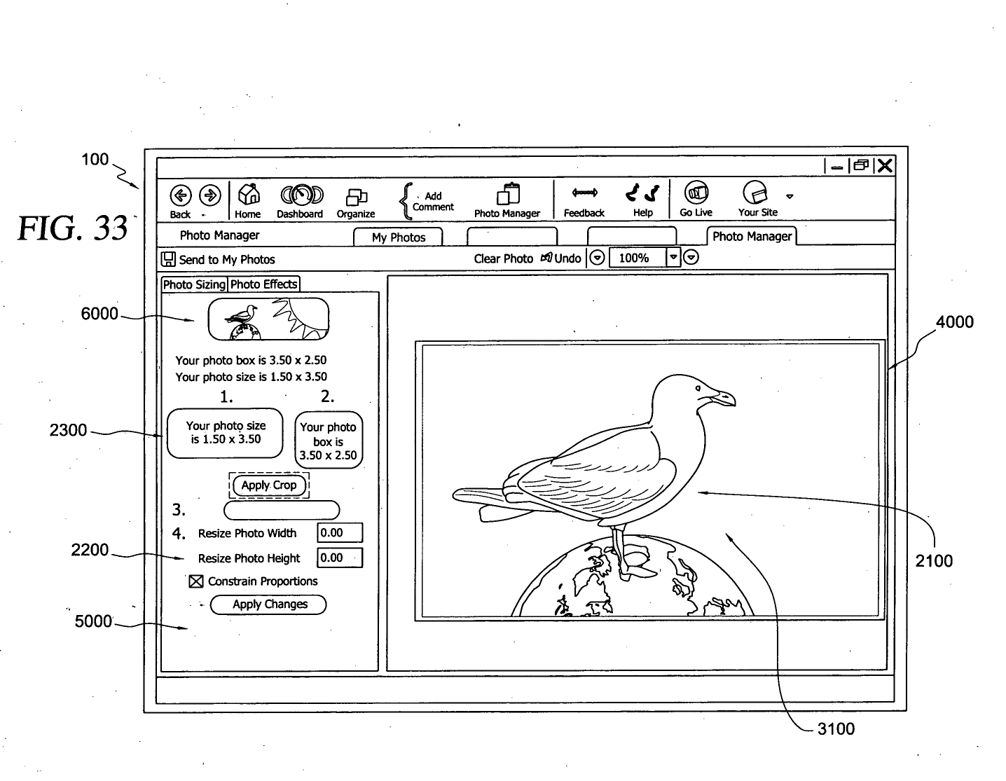

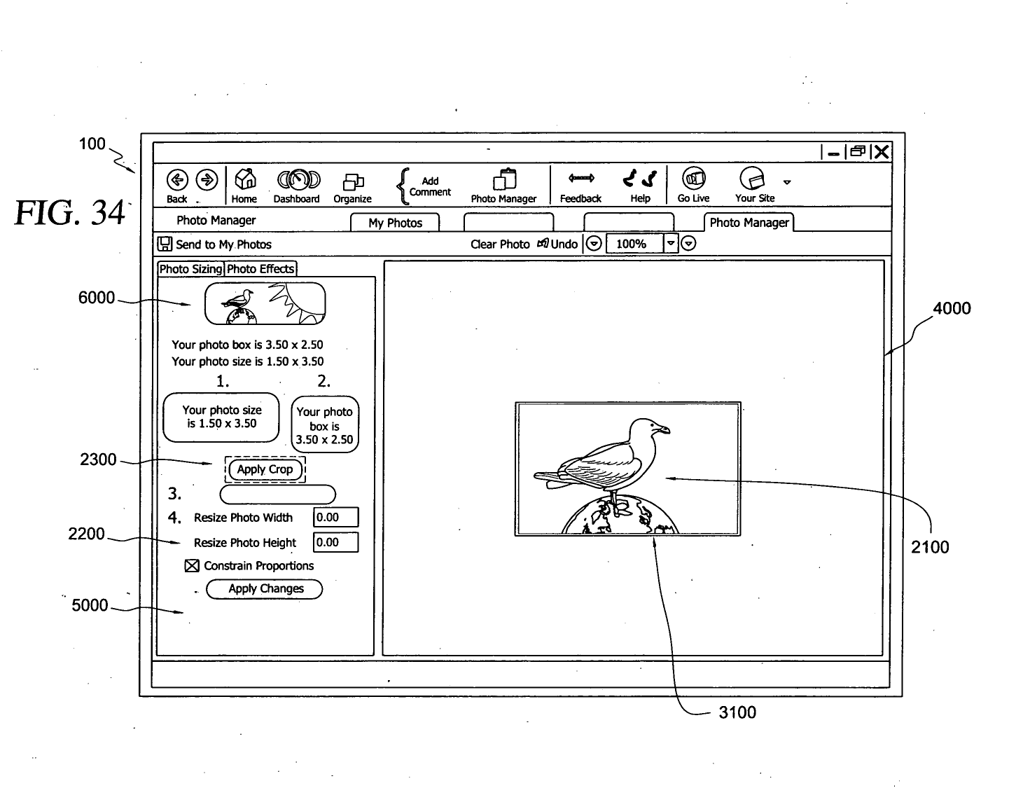

As illustrated in FIGS. 32-34, an interface 100 provides access to the photo manager 200, preferably also including the resize tool 220. In one preferred example, as shown in FIG. 33, the resize tool 220 may be operated though the resize control 4 located within the tool area 500 of the photo manager 200. Those of ordinary skill in the art will recognize that the resize control 4 may allow resizing of the photo displayed in the main photo area 400 to a variety of widths and heights as desired. For example, as shown in FIG. 34, the photo has been reduced in size from 10.00″×6.00″ to 6″×2.99″, in an attempt to fit more of the seagull within the defined boundary 310 of the image editor 210. As also shown in FIG. 34, although the resize tool 220 may not necessarily resize the photo so as to fit the entire photo within the defined boundary 310 of the image editor 210, much more of the photo does fit. Furthermore, if so desired, the user may again move the image editor 210 over the photo so as to fit more of the seagull within the defined boundary 310. Accordingly, those of ordinary skill in the art will recognize that the resize tool 220 may be used to vary the size of a photo, so as to better fit the photo and/or a desired section of a photo within the defined boundary 310 of the image editor 210.

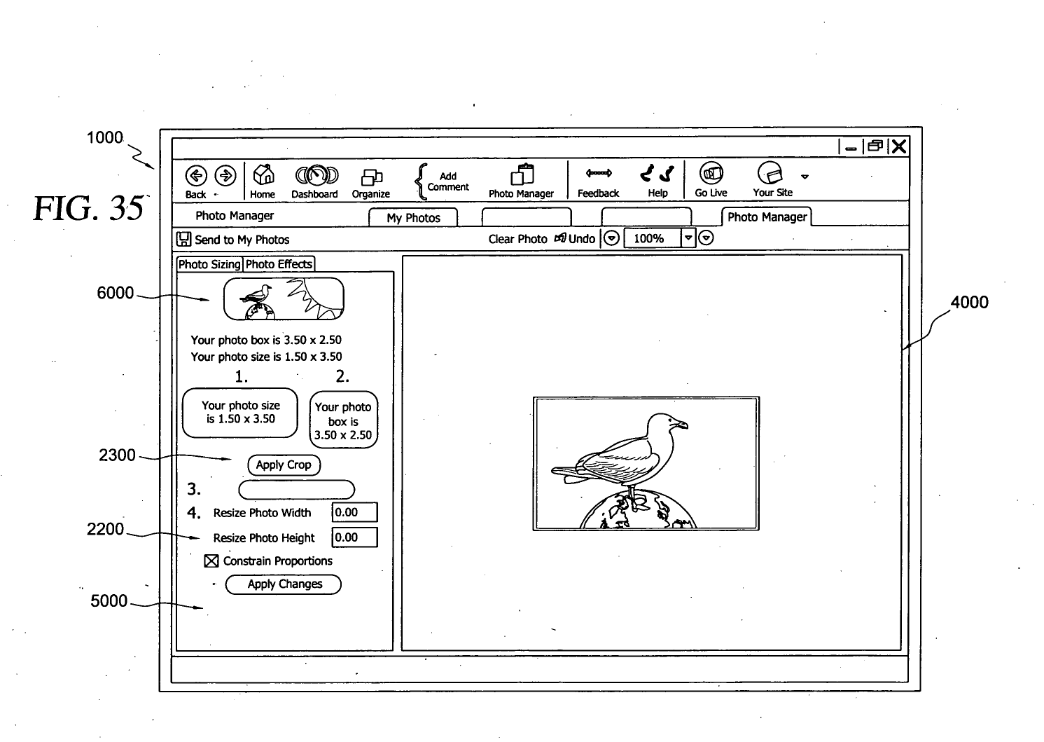

As illustrated by FIG. 35, an interface 100 provides access to the photo manager 200, including the photo crop tool 230. Those of ordinary skill in the art will recognize that, in accordance with the preferred embodiments of the present invention, the photo crop tool 230 may be used to crop the photo as defined by the boundary 310 of the image editor 210. In other words, the photo may be cropped so that only the section within the defined boundary 310 remains. In this example, the photo has been resized as illustrated in FIGS. 33 and 34, and then the photo crop tool 230 applied via the tools located in the tool area 500; that is, the user clicks on the control labeled “Apply Crop”. As a result, the photo is cropped so that only the section of the photo within the defined by the boundary 310 of the image editor 210 is displayed within the photo manager 200. In sum, the user has composed and resized the photo so that the entire seagull fits within the defined boundary 310 of the image editor 210, and then cropped the photo to the same size (3.50″×2.50″) as the defined boundary 310 (and photo box 120). Preferably, the photo manager 200 also allows the user to save and place the composed, resized and cropped photo within the photo box 120 of the layout. That is, as further shown in FIG. 35, the user is preferably provided with a save tool 600, so that the photo is saved and/or placed within the photo box 120 of the layout 110. In this example, the user preferably selects the save tool (“Save and Place in Photo Box”) 600 and, as a result, the cropped photo is placed within the photo box 120 of the layout 110.

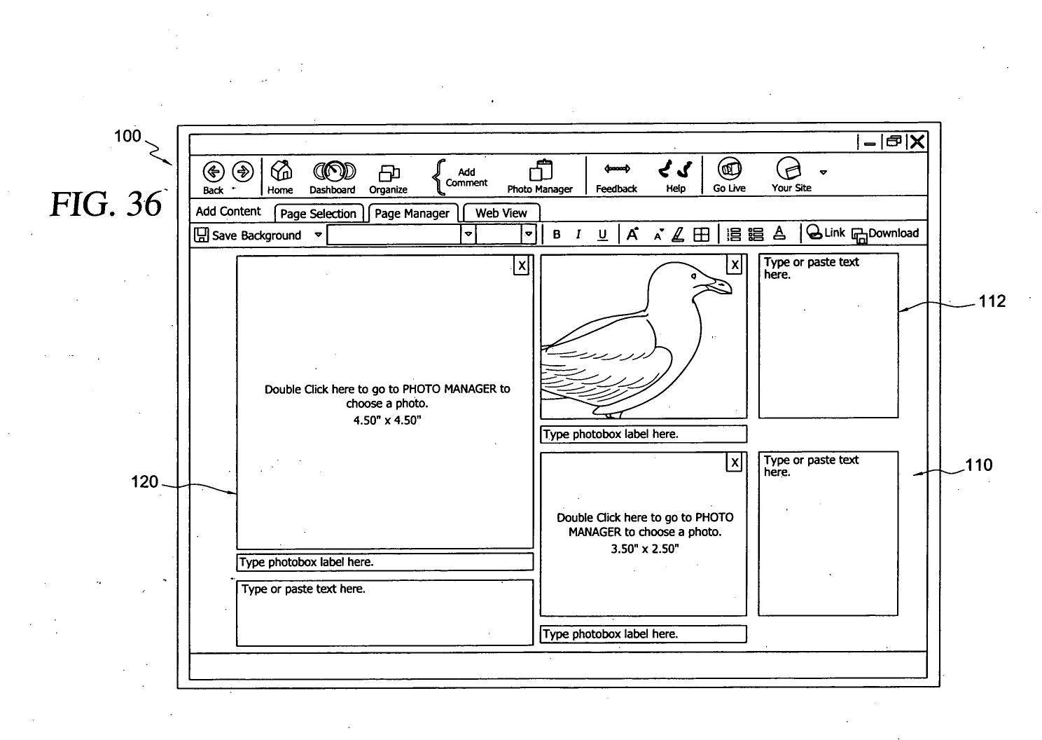

As illustrated by FIG. 36, an interface 100 provides access to the layout 110 of FIG. 25, wherein the resized and cropped photo is displayed within the photo box 120 of the layout 110. As shown in FIG. 36, those of ordinary skill in the art will recognize that the photo has now been composed, resized and cropped to fit precisely within the photo box 120. Those of ordinary skill in the art will also recognize that by clicking on the photo (e.g., with a computer mouse), the photo manager 200 may again be accessed with the photo displayed therein for further editing. Such editing may include editing with photo management tools, in accordance with the photo management capabilities of the photo manager 200. Furthermore, those of ordinary skill in the art will recognize that a different photo box may be selected, wherein the photo manager 200 is again accessed for the management of other photos.

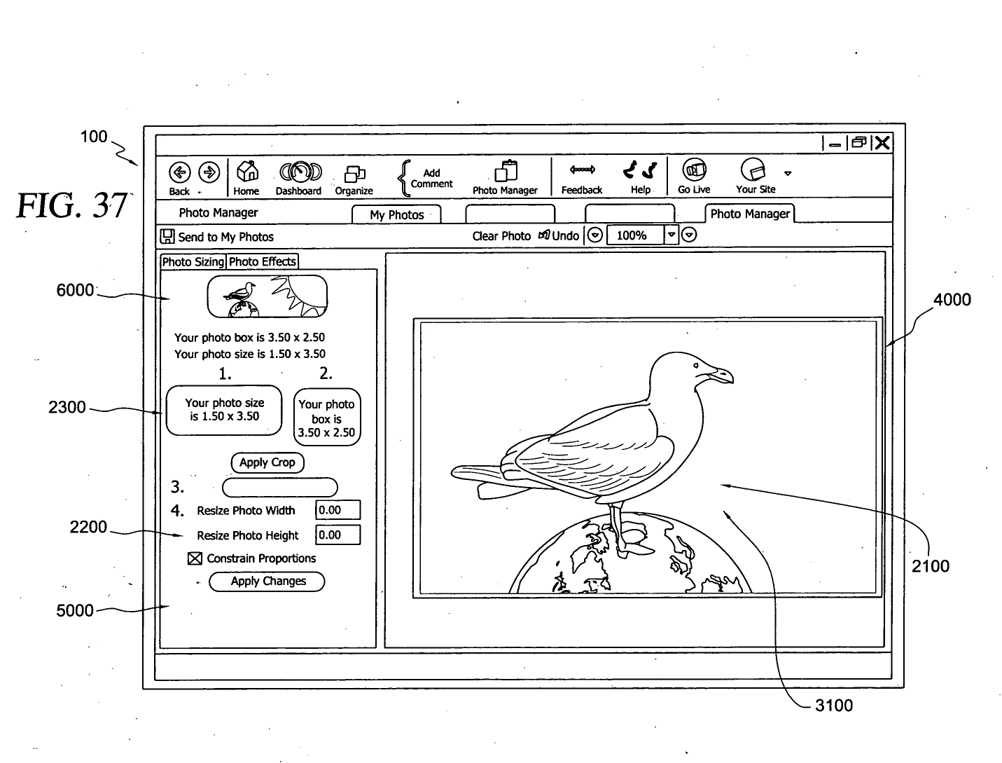

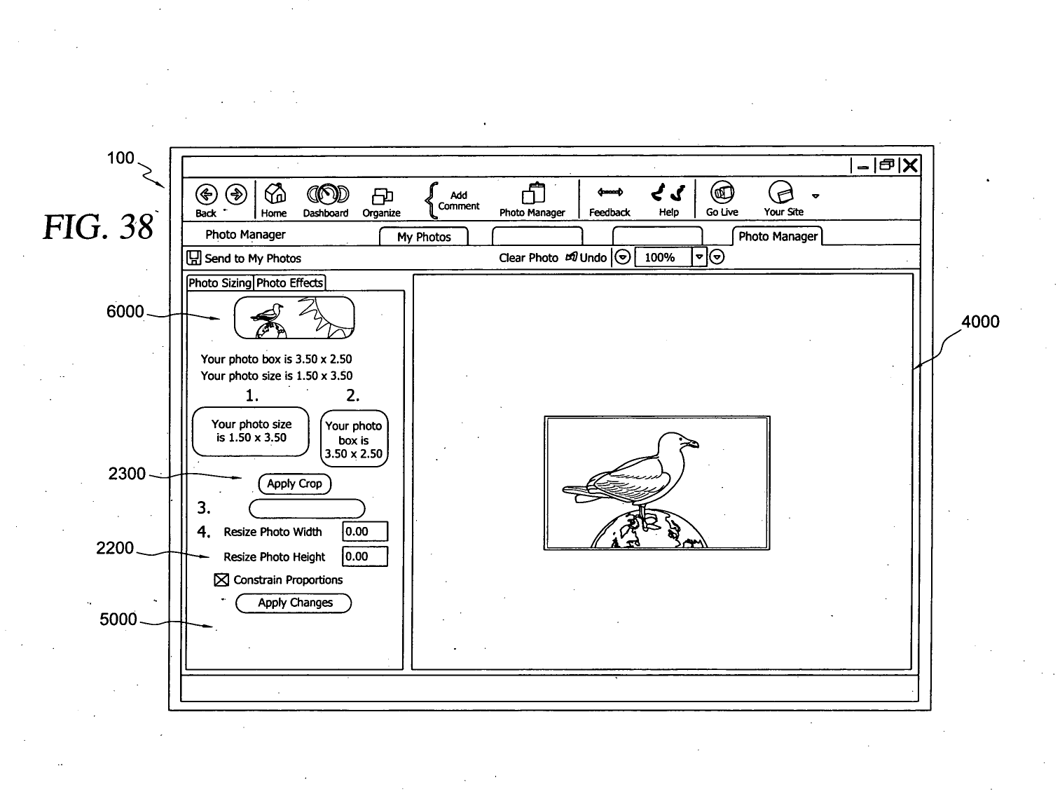

As illustrated in FIGS. 37 and 38, an interface 100 provides access to the photo manager 200, including the image editor 210, resize tool 220 and crop tool 230. In this example, however, in accordance with preferred embodiments of the present invention, the user has selected the tool 3 labeled “Fit Photo in Box”. Those of ordinary skill in the art will recognize that this tool allows the user to fit the entire photo within the defined boundary 310 of the photo box 120. Put another way, in this example, the photo manager 200 was accessed via a photo box 120 having a particular size, in this instance 3.50″×2.50″. The image editor 210 was then launched with a defined boundary 310 of the same size as the photo box 120. Finally, without any composing or resizing of the photo, the tool 3 is employed to fit the entire photo within the defined boundary 310 of the image editor 210. In sum, the photo was managed so as to have the same size as the photo box 120.

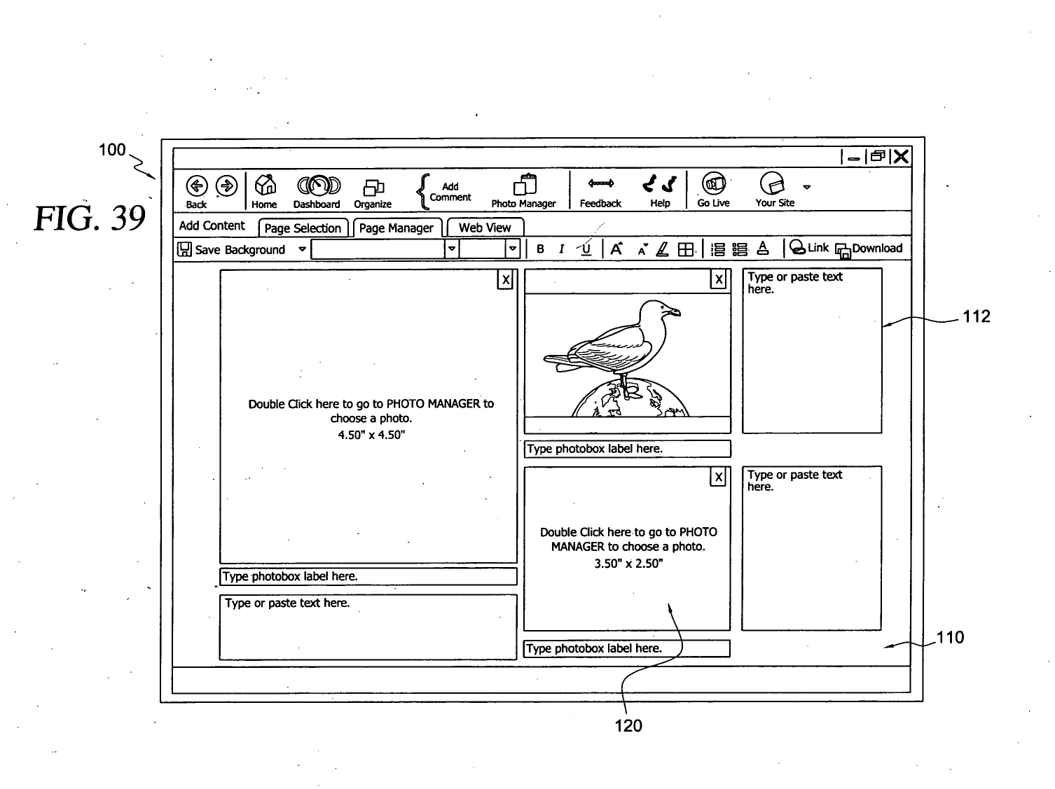

As illustrated by FIG. 39, an interface 100 provides access to the layout 110 of FIG. 25, wherein the managed photo of FIGS. 37 and 38 is displayed within the photo box 120 of the layout 110. That is, after selecting the tool (“Save and Place in Photo Box”) as shown in FIG. 38, the photo was saved and/or placed within the photo box 120 of the layout 110. Those of ordinary skill in the art will recognize that the managed photo of FIGS. 37 and 38 fits precisely within the photo box 120. Those of ordinary skill in the art will also recognize that by clicking on the photo (e.g., with a computer mouse), the photo manager 200 may again be accessed with the photo displayed therein for further editing. Such editing may include editing with photo management tools, in accordance with the photo management capabilities of the photo manager 200. Furthermore, those of ordinary skill in the art will recognize that a different photo box may be selected, wherein the photo manager 200 is again accessed for the management of other photos.

Those of ordinary skill in the art will recognize that the preferred embodiments of the present invention encompass the publication of the layout 110 including photos displayed therein. For example, in one preferred embodiment, the present invention includes tools for publishing the layout 110 to the Internet, as a web page or part of a web page. Such publication tools are well within the skill of those of ordinary skill in the art. In another preferred embodiment, the present invention includes tools for formatting the layout 110 with photos for printing with a printer. Those of ordinary skill in the art will recognize that any number of publication and display options that may be encompassed by the present invention.

Those of ordinary skill in the art will also recognize, especially in view of FIGS. 25, 32, 36 and 39 that the interface 100 preferably provides the user with what is known in the art as What You See Is What You Get (“WYSWYG”). That is, the interface 100 (e.g., the Page Manger of the interface 110) preferably provides the user with a view of the page as it would appear if finished or published at that moment, even though the page remains under construction. In other words, in accordance with preferred embodiments of the present invention, the user is preferably provided with a view of the page as it would appear if published at the moment, as shown for instance in FIGS. 25, 32, 36 and 39, without having to actually undergo additional steps such as publication as typically required. Those of ordinary skill in the art will recognize that such WYSWYG capability greatly simplifies the process of a building a page such as a web page.

Technical Design Overview of Photo Sizing, Composing and Cropping Tool

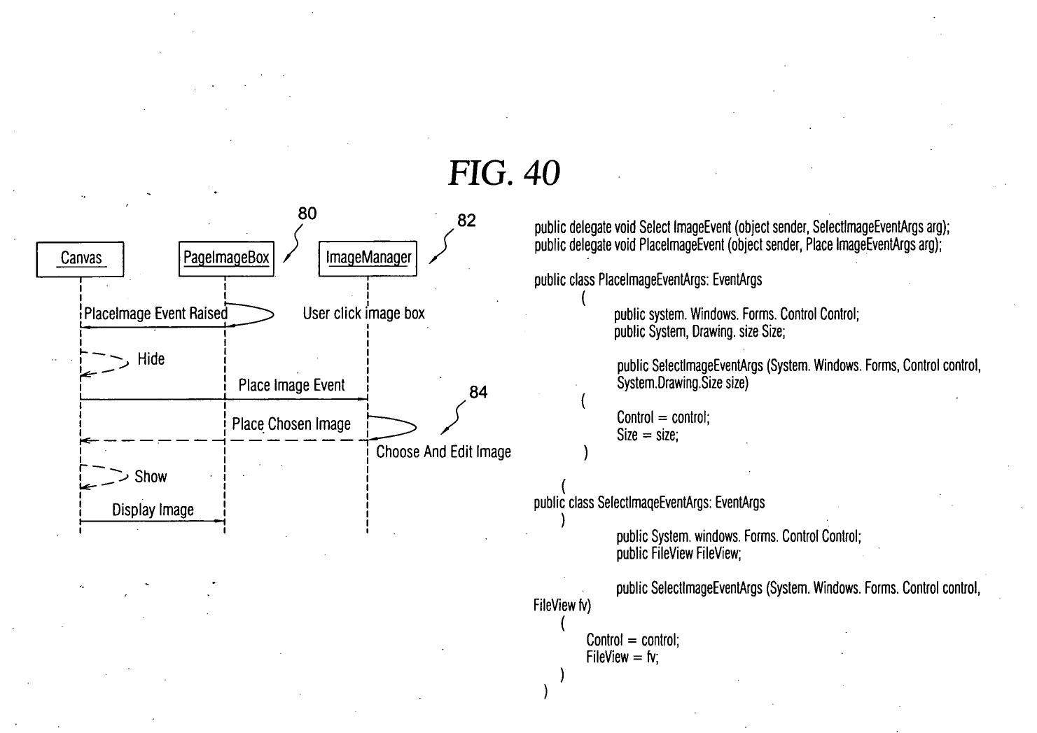

With respect to the technical design of systems, methods and computer software programs, the present invention may employ any number of preferred embodiments. For example, those of ordinary skill in the art will recognize FIG. 40 as illustrating a technical design 80 in accordance with exemplary embodiments of the present invention.

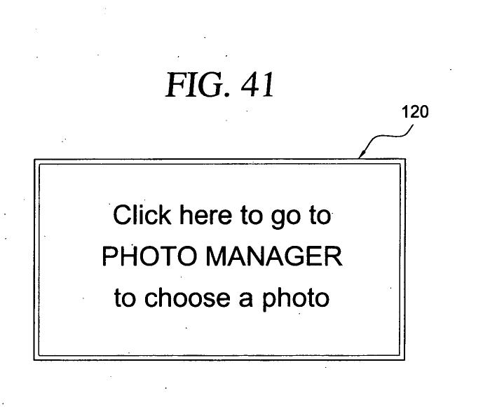

With reference to FIG. 40, those of ordinary skill in the art will recognize that in addition to being an image editor 84, the ImageManager 82 preferably acts as an Image Chooser 84. This type of event is preferably fired when the user clicks on an ImageBox (e.g., a photo box 120) from either a DirectoryManager's Directory Listing Control (not shown) or a Page Manager's ImageControl (not shown). For example, as described throughout this application, there is provided an ImageBox (e.g., a photo box 120) as shown in FIG. 41. When this box 120 is clicked, a SelectImage event is raised from each of the controls, as those of ordinary skill in the art will recognize from the illustrated instructions of FIG. 40. The event is bubbled up to the MainForm. At this point, the current manager is hidden and ImageManager 82 becomes active and placed into the “PlacingImage” state, as those of ordinary skill in the art will also recognize from the illustrated instructions of FIG. 40. Preferably, the SelectImage event contains the sender control and size of the ImageBox 120. The ImageBox 120 size is preferably passed on to ImageManager 82. Extra functions are preferably added (e.g., to the controls for the cropping tool 230), such as:

allowing the user to apply a crop of the selected size,

display of the image editor 210 size,

allowing the user to save the image and return to the previous manager.

Technical Review of Computer Systems

Those of ordinary skill in the art will further recognize that the systems, methods and computer software instructions illustrated above may be contained as a utility, program, subprogram, in any desired computer accessible medium. In addition, the present invention may be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

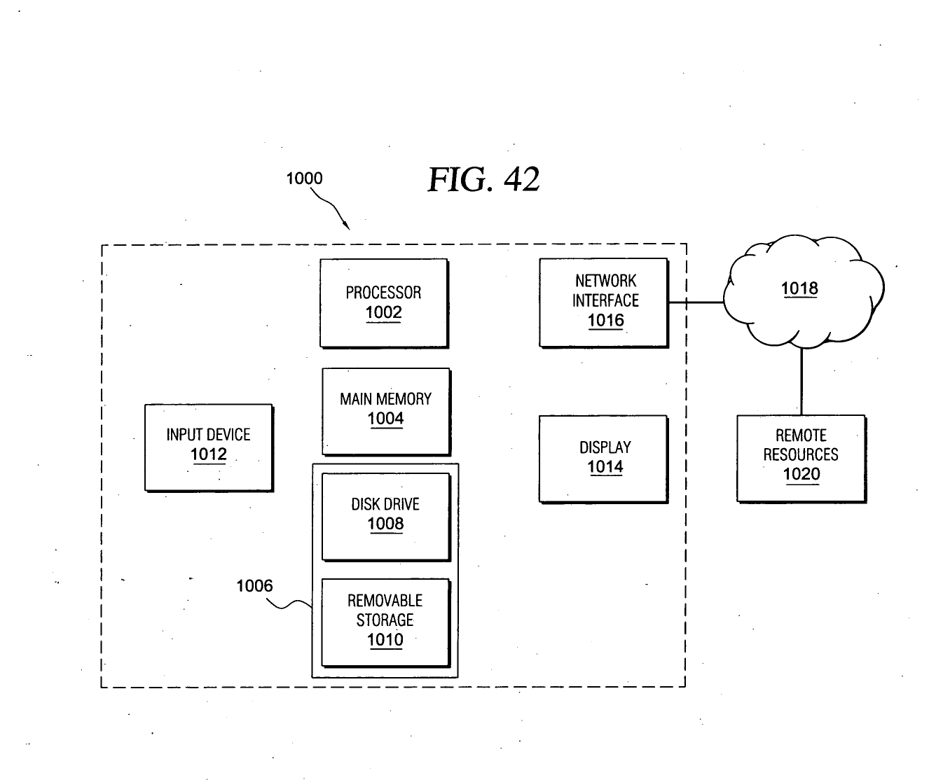

FIG. 42 illustrates an exemplary block diagram of a computer system 1000 that may implement the interfaces and the methods discussed above. The computer system 1000 includes one or more processors, such as processor 1002, providing an execution platform for executing software. The processor 1002 may also execute an operating system (not shown) for executing the software in addition to performing operating system tasks.

The computer system 1000 also includes a main memory 1004, such as a Random Access Memory (RAM), providing storage for executing software during runtime and mass storage 1006. The mass storage 1006 may include a hard disk drive 1008 and/or a removable storage drive 1010, representing a floppy diskette drive, a magnetic tape drive, a compact disk drive, or a nonvolatile memory where a copy of software or data may be stored. Applications and resources may be stored in the mass memory 1006 and transferred to the main memory during run time. The mass memory 1006 may also include ROM (read only memory), EPROM (erasable, programmable ROM), EEPROM (electrically erasable, programmable ROM).

A user interfaces with the computer system 1000 with one or more input devices 1012, such as a keyboard, a mouse, a stylus, or any other input device and views results through a display 1014. A network interface 1016 is provided for communicating through a network 1018 with remote resources 1020. The remote resources 1020 may include servers, remote storage devices, data warehouses, or any other remote device capable of interacting with the computer system 1000.

What has been described and illustrated herein are examples of the systems and methods described herein along with some of their variations. The terms, descriptions and figures used herein are set forth by way of illustration only and are not meant as limitations. Those skilled in the art will recognize that many variations are possible within the spirit and scope of these examples, which intended to be defined by the following claims and their equivalents in which all terms are meant in their broadest reasonable sense unless otherwise indicated.

What is claimed is:

1. An interface tool for content management, said tool comprising:
an interface for presenting a user with a layout comprising at least one content management module;
the at least one content management module enabling a user to provide a desired content within the layout; and
the at least one content management module enabling management of the content.

2. The interface tool of claim 1, further comprising means for assembling a page based on the layout and content provided via the at least one content management module.

3. The interface tool of claim 1, wherein the layout is selectable from a plurality of prescribed layouts.

4. The interface tool of claim 1, wherein the layout is customizable by the user.

5. The interface tool of claim 1, wherein the layout comprises a plurality of content management modules.

6. The interface tool of claim 1, wherein the at least one content management module comprises a module for providing e-commerce capability.

7. The interface tool of claim 1, wherein the at least one content management module comprises a module for providing text.

8. The interface tool of claim 1, wherein the at least one content management module comprises a module for managing a web form, wherein the module for managing a web form comprises:
a user interface comprising a design space, the user interface providing for the user to enter at least one text element in the design space; and
a parsing tool for translation of the at least one text element into at least one input object for the web form.

9. The interface tool of claim 8, further comprising at least one report associated with data captured via the input object of the web form.

10. The interface tool of claim 8, wherein the text element is selected from the group consisting of dashes, brackets and parentheses.

11. The interface tool of claim 8, wherein the input object is selected from the group consisting of a text box, a radio button and a check box.

12. The interface tool of claim 1, wherein the content management module comprises a module for managing a photo or image, wherein the module for managing the photo or image comprises:
a photo manager comprising an image editor and a resize tool;
the image editor having a defined boundary and superimposable over a photo; and
a resize tool providing for resizing at least a section of the photo within the defined boundary of the image editor.

13. The interface tool of claim 12, wherein the image editor is movable over the photo so that a desired section of the photo rests within the defined boundary of the image editor.

14. The interface tool of claim 12, further comprising a cropping tool for cropping the photo as defined by the boundary of the image editor.

15. A method for managing content, said method comprising:
providing a user with an interface for providing a layout comprising at least one content management module;
managing content via the at least one content management module; and
providing content within the layout via the at least one content management module.

16. The method of claim 15, further comprising assembling a page based on the layout and content provided via the at least one content management module.

17. The method of claim 15, further comprising selecting the layout from a plurality of prescribed layouts.

18. The method of claim 15, further comprising customizing the layout.

19. The method of claim 15, wherein the layout comprises a plurality of content management modules.

20. The method of claim 15, further comprising providing e-commerce capability via the at least one content management module.

21. The method of claim 15, further comprising providing or managing text via the at least one content management module.

22. The method of claim 15, wherein the content management module comprises a module for managing a web form, the method further comprising:
providing a user interface comprising a design space;
a user entering at least one text element in the design space; and
parsing the text element into at least one input object for the web form.

23. The method of claim 22, further comprising providing at least one report for displaying data captured via the built web form.

24. The method of claim 22, further comprising providing at least one prescribed web form layout, wherein the layout is selectable by the user from a plurality of prescribed layouts.

25. The method of claim 15, wherein the content management module comprises a module for managing a photo or image, the method further comprising:
providing a user interface comprising a photo manager, the photo manager comprising an image editor, the image editor having a defined boundary;
superimposing the image editor over at least a section of a photo; and
resizing at least a portion of the photo within the defined boundary of the image editor.

26. The method of claim 25, further comprising moving the image editor over the photo so that a desired section of the photo rests within the defined boundary of the image editor.

27. The method of claim 25, further comprising cropping the photo as defined by the boundary of the image editor.

28. A computer readable storage medium on which is embedded one or more computer programs, the one or more computer programs implementing a method for the management of content, the one or more computer programs comprising a set of instructions for:
providing a user with an interface for providing a layout comprising at least one content management module;
managing content via the at least one content management module; and
providing content within the layout via the at least one content management module.

29. The computer readable storage medium of claim 28, the one or more computer programs implementing a method for managing a web form, the one or more computer programs further comprising a set of instructions for:
providing a user interface comprising a design space, the user interface providing for a user to enter at least one text element in the design space; and
providing a parsing tool for translation of the at least one text element into at least one input object for a web form.

30. The computer readable storage medium according to claim 29, further comprising a set of instructions for the translation of the text element into the input object.

31. The computer readable storage medium of claim 28, the one or more computer programs implementing a method for managing a photo or image, the one or more computer programs further comprising a set of instructions for:
providing a user interface comprising a photo manager, the photo manager comprising an image editor, the image editor having a defined boundary;
superimposing the image editor over at least a section of a photo; and
resizing at least a portion of the photo within the defined boundary of the image editor.

32. The computer readable storage medium of claim 31, further comprising a set of instructions for moving the image editor over the photo so that a desired section of the photo rests within the defined boundary of the image editor.

33. The computer readable storage medium of claim 31, further comprising a set of instructions for cropping the photo as defined by the boundary of the image editor.

34. The computer readable storage medium of claim 28, further comprising a set of instructions for customizing the layout.
